(19) United States
(12) Patent Application Publication
(10) Pub. No.: US 2003/0212996 A1
(43) Pub. Date: Nov. 13, 2003

(54) System for interconnection of audio program data transmitted by radio to remote vehicle or individual with GPS location

(76) Inventor: Thomas R. Wolzien, Grandview, NY (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/834,375

(22) Filed: Apr. 13, 2001

Related U.S. Application Data
(63) Continuation-in-part of application No. 09/573,620, filed on May 17, 2000.
Application No. 09/573,620 is a continuation of application No. 09/054,740, filed on Apr. 3, 1998, now Pat. No. 6,233,736.
Application No. 09/054,740 is a continuation of application No. 08/597,432, filed on Feb. 8, 1996, now Pat. No. 5,761,606.
(60) Provisional application No. 60/197,314, filed on Apr. 14, 2000.

(51) Int. Cl. H04N 5/445; G06F 3/00

(52) U.S. Cl. 725/60

(57) ABSTRACT

A system and method for expediting the provisioning of goods/services to a user by providing directions from a current location for the user to a destination associated with an address embedded within or transmitted in conjunction with a programming signal. The system also utilizes user identifiers, payment information, user preferences and delivery instructions to expeditiously provide the goods/services to the user upon the user's arrival at the destination. The address provides an indication to an online information provider and/or a database within which a listing of goods/services provided by the provider and a listing of locations providing the goods/services. By comparing the various locations of the destination against the current location of the user, preferably determined using Global Positioning System data, the present invention determines which location of the destination is closest and provides directions thereto. Additionally, the present invention may be conFIG.d to utilize a MObile Transaction Enabling System (MOTES) for automatically communicating payment and other information for a user to a provider.

### CROSS-REFERENCE TO RELATED APPLICATIONS

This application is a continuation-in-part of application Ser. No. 09/573,620, filed May 17, 2000, which is a continuation-in-part of application Ser. No. 09/054,740, filed Apr. 3, 1998, which is a continuation of application Ser. No. 08/597,432, filed Feb. 9, 1996, now U.S. Pat. No. 5,761,606 the contents of both of which are incorporated herein by reference. This application also claims priority from provisional patent application Serial No. 60/197314, filed Apr. 14, 2000 the contents of which are incorporated herein by reference.

### FIELD OF THE INVENTION

The present invention relates to an electronic information access system and more specifically to a media online service access system which provides directions to a provider of goods/services advertised via an address embedded in a programming signal which carries a program segment (e.g., through television, radio, or a pre-recorded video or audio medium), while also expediting the completion of those transactional requirements necessary for a user and the provider to engage in commerce. More specifically, the present invention relates to a system and process which provides an indication of a provider of goods/services in a programming signal, determines a location of a user interested in the goods/services, and provides the user with directions to a provider whose location may be most conveniently accessed by the user, while also facilitating those transactional and other requirements necessary to engage in commerce. Further, in alternative embodiments, the present invention relates to systems which do not utilize address and/or directional information to provide the before mentioned transaction facilitating features and functions.

### BACKGROUND OF THE INVENTION

Heretofore, media receiving and display systems such as television and radio receivers have been linked to interactive information providers in only very limited ways. Some systems exist which permit the exchange of digital information with the viewer of a television program over or in combination with a television signal, but such systems have provided access to a single information source available from, for example, the broadcast or cable television operator. In such systems, the selection of information services has been entirely within the control of the broadcast or cable television operator.

At the same time, some television and radio broadcasters have begun announcing an Internet address for viewer inquiries during the course of program transmission. Access to this Internet address requires the user to utilize his or her computer. No system yet exists which provides automated and direct user access to online information providers through an address embedded in a video or audio program signal while also providing directional indicators to a location associated with the content of the program signal and facilitating those communications and transactions necessary to expeditiously provide goods/services to a user by the provider associated with the program transmission.

The recent explosion in the usage of online information services through digital networks such as the Internet, Prodigy (R), America Online (R) and Compuserve (R), for example, indicate that the demand for access to readily available up-to-date or detailed information is increasing. The viewer of a video program, whether the program is received through broadcast or cable means, or from a pre-recorded medium, may often seek to discover more information which relates to a topic presented in the video program. Since television programs and recordings are of finite length, they often do not contain all the related information which a consumer may wish. Additionally, the information contained in television programs often may not be timely. Therefore, it would be desirable for there to be a system which automatically and directly provides access to an online information provider through an address which can be extracted from an audio or video program such as a television program, commercial or news story. With such a system, several benefits would be obtained. For example, adults and children viewing an educational or historical video program could easily locate additional materials provided in text or still picture by the producers of the video program by accessing more information from the producers digitally through the online address. Consumers seeking more information about a specific advertised product could easily find such information by accessing the online address of an information provider designated by the advertiser. News program viewers seeking specific information from news stories or more detailed information could easily access such information through an online information provider designated by the producers of such program.

The online service access system could be used to provide still other benefits to consumers, business owners, and the government. For example, an automobile manufacturer could make information available directly to a consumer through an online address embedded in a video presentation so the consumer could reach its online site quickly to ask for more information, to request a test drive, or to purchase parts. Through such a system, a grocery store could advertise and receive orders through its online site from customers for home delivery, or for other shopping needs. A catalog retailer could use such system to provide rapid access to consumers, after airing a commercial, to its catalog in online form and to enable orders to be placed readily through its online site. A record company could use such system to enable customers to order a recording while listening to a song or viewing a music video. Government agencies, e.g., the Internal Revenue Service, military recruiters, or health agencies, for example, could use such system to provide consumers with readily available information following the airing of public service announcements regarding regulations, programs, or public health concerns, e.g., cancer, AIDS, and heart disease. Educators and students could use such system to obtain more detailed or up-to-the-minute information from online bulletin boards and databases regarding topics presented in a video program, even though the program was recorded some time in the past.

Additionally, heretofore, broadcast radio and television programs have been limited in providing information related to goods and/or services presented during programs or advertisements. These limitations are often due to the fact that programmers do not have time within programming schedules to identify where providers of such goods/services are located or contact information. Since advertisements are commonly priced based upon the time length, hour of the day, and listening audience, advertisers generally do not provide location and contact details during their slotted time due to economic considerations. For example, a chain of fast-food restaurants often does not desire to pay for the “air time” necessary to identify every location of their various facilities. Identifying every restaurant location is undesirable because it is expensive, in that additional “air time” is needed to identify numerous facilities (especially in a large metropolitan area), and because most users of a radio program or viewers of a television program will not pay attention to a long advertisement reciting numerous and, in most instances, irrelevant restaurant locations.

Similarly, radio programmers commonly do not provide credits to the various recording artists aired on their programs. Instead of taking precious seconds to identify an artist, the album or compact disc title on which a present song is recorded, and record store locations, radio programmers prefer to fill such time slots with revenue generating advertisements. Thus, currently available radio programming systems do not allow advertisers, artists, and programmers to efficiently provide detailed information pertaining to the content of their radio transmissions.

Further, even if a system was available which allowed a user to receive links to information content, such as directions, users of such a system would still encounter delays in processing orders, executing transactions and receiving the goods/service presented in the programming content. Users might be able to progress quickly, for example, from a current location to an advertised retail establishment (such as a McDonalds® restaurant) only to find that several other users, who listened to or otherwise received the same programming content, have also decided to travel to the same location providing the goods/services promoted in the programming content. As can be readily appreciated, a user might be discouraged from frequently using the systems identified herein if the user is often faced with arriving at a location where many other receivers of the programming content have already arrived and the location is excessively crowded.

Therefore, a system is needed which combines the capabilities of GPS positioning systems (when available), the convergence of online information providers with programming signals to provide additional valuable information, and/or the use of automated payment systems to efficiently promote, identify, direct and expedite commerce between a provider and user receiving a programming signal. Such a system preferably allows a programmer or advertiser to provide links to information content (such as directions) associated with a programming signal which may be accessed from a database and then presented as directions to the user. Additionally, such a system allows a user and promoters to engage in those communications necessary to process, on an expedited basis, user requests for the goods/services promoted in the programming content prior to, at the time of, or after the arrival of the user at the retail location.

### SUMMARY OF THE INVENTION

The media online service access system of the present invention provides a system and process which links video and audio program content with online information signal content. The system provides heretofore unattained direct automated user access from a media program such as a received or pre-recorded television or radio (audio) signal to an online information provider through a link provided in the media program. The access system receives a programming signal representing a video or audio program or a combined audio/video program from an available medium (e.g., broadcast and cable television and radio, or a pre-recorded medium such as a tape or disc). Embedded in the programming signal, for example, in the vertical blanking interval, or otherwise encoded in the programming signal in such manner as not to interfere with the displayed image, is an information signal representing an electronic address of an online information provider. The online information provider can be any one of millions of interactive information providers which can be accessed through the exchange of digital information signals, for example, a publisher who is available through the Internet for interactive transactions. As the media program is received for reproduction on a video display or audio sound system, the access system extracts the embedded electronic address for use in directly accessing the online information provider at the selection of the user.

Preferably, the address is stored at the time of extraction, for use in accessing the online information provider at the selection of the user. The duration for which an extracted address signal is stored may be relatively short, as in the case where the address is transmitted and refreshed continuously or at very short intervals, e.g., once per each frame of a video signal, or it may be longer, as when an address is transmitted only at selected intervals of a program.

Upon successfully extracting an electronic address, the access system provides an indicator signal to the user that more information is available. The indicator signal may take the form of a message displayed on a video screen, or other indicators such as a light, a sound or a wireless tactile indicator, e.g., vibrating wristband or clip-on unit. Alternatively, the video or audio program may contain a logo or message to be presented to the user at points in the program which coincide with the presence of an embedded online information provider address, which, in such case, would eliminate the need for the access system to incorporate specific structures to provide an indication to the user, in response to a successful extraction of an online information provider address.

After receiving the indicator signal, if the user desires more information, the user may request access to the online information provider through a command to the access system, e.g., through a pushbutton, user control keypad, voice command, mouse, touch pad, touchscreen, or other input device. Upon receiving such command, the access system automatically establishes a digital communications link with the online information provider through the transmission of a signal containing the extracted address. Preferably, upon establishment of such communications link, the access system enables interactive communications with the online information provider.

In another embodiment of the invention, the extracted address can be used without first being stored, as in cases where a connection already exists between the access system and a network. Where such connection exists, the access system provides an indicator signal to the user upon successful extraction of an online information provider address. However, in this embodiment, the access system waits to receive a user command to initiate access, and only after receiving such command does the access system extract the next received address from the programming signal and use it to establish a direct connection to the online information provider.

In another embodiment, after accessing an online information provider, the access system receives information from the online information provider and processes it for reproduction on a video or audio reproducing system. For example, the information can be displayed on the television screen in place of the television broadcast signal, on a separate computer monitor or other display device, or together with the television broadcast signal in a picture-in-picture format. In this way, the user can fully explore all of the related information available from the online information provider. Preferably, the access system is provided with hardware to reformat the received information signal for display upon an otherwise incompatible system, for example, to convert a digitally encoded video signal to an analog signal for reproduction on a conventional television set. Preferably, the access system is also provided with hardware for receiving and processing user commands for transmission to the online information provider for providing user communication transactions with the provider.

Further, since currently available audio and video broadcast technologies do not allow a person walking or driving a vehicle to learn of the nearest location of a desired facility to purchase advertised products/services, the present invention provides a system for interconnecting over the air analog or digital programming signals with location data determined via any known or to be known location determination system (for example, GPS or Loran). In conjunction with such a location determination system, the present invention suitably displays, by visual, audible or other method, the nearest and/or most convenient location of a business being advertised. Of course, additional content (i.e., content that is not directions) related to the programming can also be displayed on a screen in a user's PDA or vehicle or otherwise communicated between the user and the provider.

The present invention additionally facilitates those communications and transactions necessary to expedite the delivery of goods/services from the provider at a location promoted in a programming signal (or a location designated by the provider). In the preferred embodiment, after a determination of a user's current location is made and the nearest location providing the goods/services promoted in the programming signal is identified, the system suitably establishes a communications link between a specific location (or the provider, if a centralized center is utilized) and the user such that the user may request the promoted goods/services and/or alternative goods/services. For example, an advertisement for McDonalds may promote Big Macs but the user may request other food items in addition to, or in replacement of, those advertised in the programming signal. The present invention facilitates such individualization by providing menus and accepting special requests from users. Additionally, the system enables the user to pick-up their order at a special drive thru window with little or no waiting. For example, a drive-up window is provided which is especially designated for users equipped with a passive or active storage and/or trigger device which facilitates interactions with mobile transaction enabling systems. Examples of such systems include EZPass and others. For purposes of simplicity such MObile Transaction Enabling Systems are hereinafter identified as “MOTES.”

Further, an alternative embodiment of the present invention may also be conFIG.d such that positional and/or directional information is not provided and/or utilized. In such an embodiment, the system displays additional content related to a programming signal and utilizes MOTES to facilitate the completion of any transactional details involved in the procurement of goods/services associated with the additional content.

Additionally, the communications link between the user and a provider preferably enables the user to complete those transactional requirements, with or without MOTES, necessary to expedite the delivery of the desired goods/services. Such transactional requirements may include, for example, billing arrangements (i.e., credit card authorizations) and delivery terms (for example, how soon the user will arrive at the location or whether the user will need assistance with the delivery (for example, a handicap driver may need assistance pumping gasoline)). Additionally, the system preferably enables providers to divert users to alternative locations. For example, when the goods/services requested by users are in short supply at a nearest location (for example, the store sells out of the promotional item), or delivery of the goods/services will be delayed or impossible within a reasonable time period due to other users responding to the same location, the system suitably directs the user to (when a GPS or other location determination system is available) and/or identifies a location where the request can be expeditiously fulfilled. When the system is not equipped with location and direction determining equipment, the user is only provided the location.

In one embodiment of such a system, the present invention incorporates an on-line address in a programming signal similar to the various other embodiments specified herein. The on-line address corresponds with the content of the programming signal. The system also preferably advises the user that additional information is available through an appropriate stimuli (i.e., a visual, audible, or tactile indicator). Upon user direction, the system extracts the address from the programming signal and combines the extracted address with any (when available) location information for the user (which is preferably determined via a GPS receiver) and other user identifying information (for example, billing information) into a signal which is transmitted to a suitable processor, server, or network of servers. The processor receiving the combined signal then determines directions from the GPS determined position (when available) to the desired facility, or (when not available) the location of at least one facility associated with the programming signal and suitably transmits such directions back to the user for display. The processor then preferably queries the user as to whether they desire to exercise an automated purchase of the promoted goods/services, alternative goods/services, and/or additional goods/services. If the user responds favorably, the processor preferably establishes the necessary communications links and completes those actions necessary to allow a user to expeditiously receive the promoted, alternative, and/or additional goods/services, preferably by using a MOTES compatible system.

In another embodiment, the present invention utilizes the on-line address to access data containing location and other information which is stored in a device local to the user (for example, a hard drive in an automobile). In this embodiment, the data is transmitted to the vehicle prior to the transmission of the programming signal containing an address. The system receives the programming signal and online address, retrieves the content identified at the online address from the storage device and, when available, utilizes the GPS data to determine directions, or when GPS data is not available, at least one location of a facility. When the user desires to utilize a MOTES compatible system, the system extracts access instructions (for example, a telephone number) and ordering information from the pre-stored data. Such information is suitably utilized by the user or the user's system to submit an order for the promoted goods/services to the provider and complete the transactional requirements such that the goods/services are expeditiously provided to the user upon the arrival of the user at the location. Preferably, MOTES is designed to require minimum user interaction such that the user may focus their attention upon other activities, such as driving a car. In such an embodiment, the user preferably inputs by voice, keypad, touch screen, mouse, or otherwise a request which is then automatically communicated by MOTES to a location identified as providing the requested or alternative good/service. Billing information (for example, a credit card number) may also be communicated by MOTES to the location at this time.

In still another embodiment, instead of the user's device receiving information from a central location and storing the information in a database, a prerecorded database is utilized. Such a database may be provided, for example, on a CD-ROM, DVD, portable non-volatile memory devices (for example, Flash-ROM, EEPROM, MemoryStickTm), continuously powered volatile memory devices, magnetic disc, or other magnetic and/or optical memory devices. The database preferably utilizes an indexing scheme which allows retrieval of information related to the online address embedded in the programming signal. In this manner, mapping information, for example, can already be resident in the user device. As for the download embodiment, this embodiment also provides for the remote entry of orders and transaction processing by a user to a location/provider identified by the system based upon the user location and the content of a programming signal. Thus, regardless of the data retrieval systems utilized, the present invention provides a system which expedites the delivery of goods/services promoted in a programming signal to a user at a location identified based upon GPS location information (when such location information is available) by facilitating those communications and transactions necessary to communicate and process a request by a user for promoted or alternative goods/services.

### BRIEF DESCRIPTION OF THE DRAWING FIG.S

FIG. 1 is a block and schematic diagram illustrating the online service access system in accordance with the present invention. 5 FIG. 2 is a block and schematic diagram of an access controller used in the online access system of FIG. 1.

FIG. 3 is a block and schematic diagram of another embodiment of an access controller used with a computer in accordance with the present invention.

FIG. 4 is a depiction of one embodiment of the present invention wherein directions relating to a program or advertisement on the radio or car television are displayed to a user in a vehicle.

FIG. 5 is a block and schematic diagram of the elements of one embodiment of the present invention wherein directions for a facility related to content provided in a programming signal is obtained at a vehicle via a wireless communications link with a data processing center, operable connected to an on-line information provider.

FIG. 6 is a block and schematic diagram of an access system utilized in a GPS embodiment of the present invention.

FIG. 7 is a block and schematic diagram of an embodiment of the present invention wherein a user connects directly to the Internet, bypassing the data processing center shown in FIG. 5.

FIG. 8 represents a logic flow diagram of a direction determination system according to any of the location determining and direction providing embodiments of the present invention.

FIG. 9 represents a logic flow diagram of an expedited request processing system according to the automated transaction processing embodiment of the present invention.

FIG. 10 represents a logic flow diagram of an automated transaction processing system according to any of the automated transaction processing embodiments of the present invention.

### DETAILED DESCRIPTION OF THE PREFERRED EMBODIMENTS

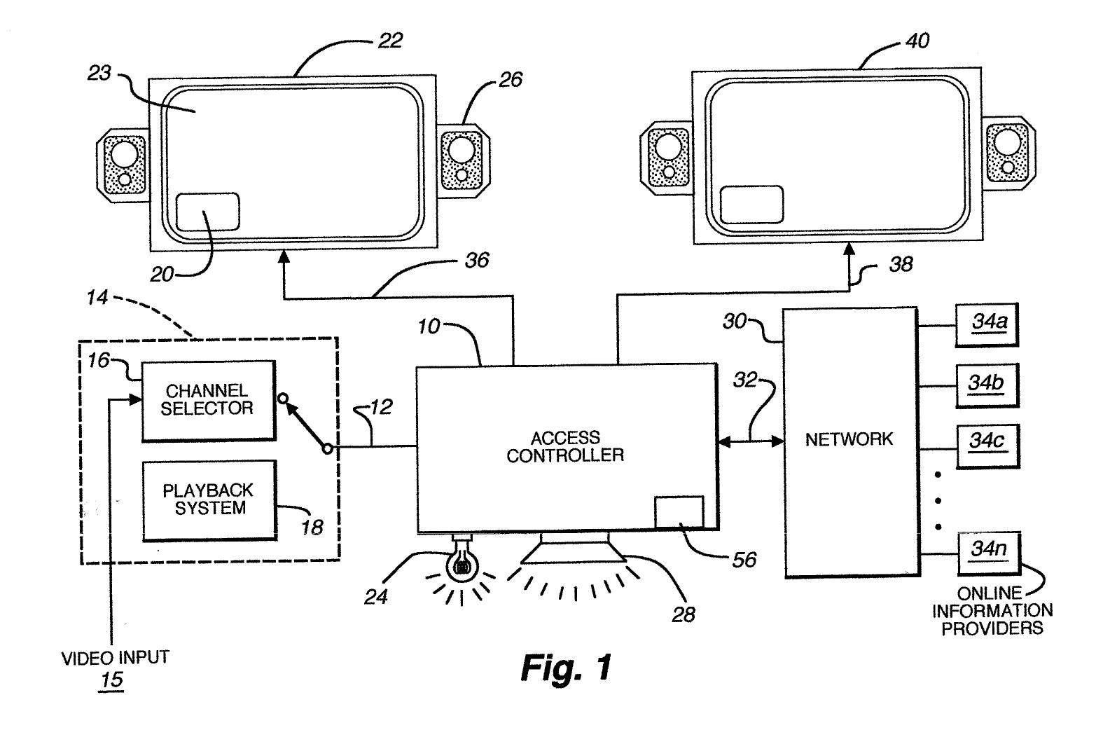

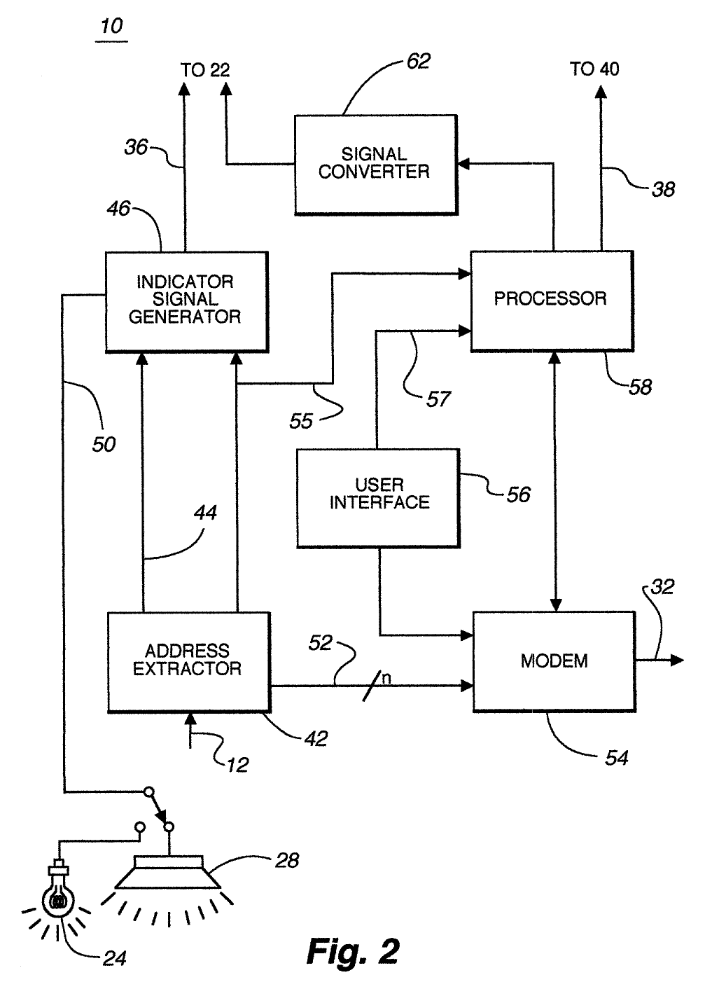

An online service access system according to the present invention is illustrated in FIG. 1. Referring to FIG. 1, the online service access system includes access controller 10 which incorporates all components necessary to provide online access and to access received online information signals. Access controller 10 is constructed to receive a programming signal 12 from a broadcast, cable or prerecorded medium program in conventional form from a video signal source 14. Video signal source 14 can be selectively switched to provide output from a channel selector 16 connected to a cable or broadcast video input 15 or from a video playback system 18 which may be, for example, a videocassette recorder or an analog or digital videodisc device. It will be appreciated that channel selector 16 may be provided in a unit separate from playback system 18, or within access controller 10 itself. Alternatively, access controller 10 can be constructed to receive and decode program signals at radio frequency as received from a broadcast or cable video source, or as downconverted to baseband by, for example, the front end receiving circuitry of a video cassette recorder or digital video disc device. It will also be appreciated that the function and results provided by access controller 10 are not dependent upon which of many available playback systems is connected thereto, whether such systems are analog or digital in format, or whether such playback systems operate upon videotape, audiotape, or disc media.

Access controller 10 is connected via a primary output signal line 36 to a conventional reproducing system 22 such as a television set, and is optionally connected through a second output signal line 38 to a high resolution reproducing system 40, such as a computer monitor. In addition, access controller 10 is connected to a public or private network 30 through an information signal carrier 32, e.g., telephone line, coaxial cable, fiber optic link, cellular, radiotelephone, or satellite link. Network 30 may be any private network (for example, America On Lines® or Excite@Home®), public network (for example, the Internet or World Wide Web), local area network or wide area network (for example, an office network or a company network), circuit-switched network, or any other configuration of devices which facilitate the exchange of electronic information. Network 30 is used to route address and information signals between access controller 10 and a selected one of a plurality of online information providers 34a, 34b, 34c, . . . 34n. Access controller 10 receives from the online information provider, through network 30, information signals having a video or audio program content and selectively provides, through appropriate conventional processing, a conventional program signal or a high resolution signal for reproduction upon standard reproducing system 22, or high resolution reproducing system 40, respectively.

The internal construction of access controller 10 is described with reference to FIG. 2. Access controller 10 is provided with an address extractor 42 which receives the programming signal 12. Address extractor 42 includes hardware and/or software to detect, decode and store an address which has been embedded in a video or audio program signal. Among the ways which exist to detect an address signal transmitted in conjunction with an analog video signal, address extractor 42 may be constructed to detect a digital address which is transmitted during a vertical blanking interval or other portion of a conventional video signal in such manner that displayed image quality is not affected. For example, the address signal can be transmitted during a portion of a video signal such as in the vertical interval, in sync or through changes in the luminance or chroma signals. Address extractor 42 is constructed to electronically store, e.g., via a register or memory device (not shown), the detected address for use in accessing the online information provider at the selection of the user. The address signal may be transmitted at very short intervals, e.g., once for each frame of a video program such that storing and refreshing of the extracted address signal occurs at very short intervals. Alternatively, the address signal may be transmitted at longer intervals, i.e., at discrete intervals in a program such that the duration in which an extracted address signal is stored is much longer.

For cases in which a video or audio program is digitally encoded, address extractor 42 may be constructed in any of several existing ways to detect an address signal which is received in conjunction with a digitally encoded video or audio programming signal 12. The details of the construction of address extractor 42 are well known in the art and need not be described in further detail.

Address extractor 42 has an output connection to an indicator signal generator 46. The indicator signal generator 46 signals the user that more information relating to the program is available, such information being accessible through an electronic address when address extractor 42 has decoded such address from the programming signal 12. Indicator signal generator 46 causes, for example, a video image 20 (e.g., picture within picture, logo, or icon) to be displayed with the video program signal on reproducing system 22 to signal the user that an address of an online information provider has been stored and that additional information is available. Instead, or in addition to such visual display, indicator signal generator 46 may signal the user by activating a light 24 or other visual indicator located on an exterior panel of access controller 10 or of reproducing system 22.

Alternatively, indicator signal generator may cause a sound to be produced on a speaker 26 of reproducing system 22, or by a speaker 28 provided in access controller 10. Here again, the design of indicator signal generator 46 is well known in the art. Access controller 10 is provided with a user input interface 56 for receiving a user command which automatically initiates establishment of a direct digital communications link to an online information provider through an address detected from the programming signal 12 by address extractor 42 and permits interactive communications between the user and the online information provider. It will be appreciated that many conventional input interfaces are well suited for use as user interface 56 because of their compatibility with conventional television and audio sound systems. Among such input interfaces are infrared, radio and audio frequency interfaces which decode single key or multiple key sequence input from a wired or wireless remote user control.

Preferably, user input interface 56 detects when a special purpose button on a remote user control has been pressed and provides a responsive signal which automatically causes the stored address of the online information provider to be retrieved and transmitted. User input interface 56 can also be constructed to detect when a special sequence of keys has been pressed on a conventional user control (e.g., a sequence such as “ENTER,” “ENTER,” “+VOLUME”) and to enable interactive communication with the online information provider. Alternatively, user input interface 56 can be implemented by any appropriate microcomputer type user interface, e.g., mouse, touch pad, touchscreen, trackball, joystick, pushbutton, eraser head, or other such device. Preferably, user interface 56 is constructed to provide and receive transmissions of digital information signals through modem 54 to the online information provider, thereby enabling interactive user access with the online information provider for conducting detailed information searches, conducting transactions, and sending or posting messages to the accessed provider.

Access controller 10 is provided with a modem 54 for transmitting and receiving digital information signals between access controller 10 and public switching network 30 through an information signal carrier line 32. Modem 54 demodulates incoming information signals and outputs them to processor 58 which extracts a video and/or an audio signal 38. Preferably, access controller 10 includes a signal converter 62 for adjusting or converting an incompatible signal for display upon conventional reproducing system 22, such as a television set, either in place of the television signal, superimposed over the television signal, or in picture-in-picture format, as controlled by the user. Alternatively, processor 58 provides the video signal on line 38 to a high resolution reproducing system 40, such as a computer monitor. Indicator signal generator 46 may also incorporate a switch (not shown) which automatically switches off the primary output signal 36 whenever a signal appears at the output of signal converter 62. In this manner, information signals received from online information providers will be automatically displayed on conventional reproducing system 22 in place of the ordinarily displayed video signal 36.

Processor 58 can also receive the input video or audio electronic program signal through a line 55 output from address extractor 42 (although direct connection of the programming signal line 12 is possible). In this manner, processor 58 may be constructed to operate upon the video or audio signal in conjunction with information signals received from an online information provider to generate a “picture within picture” signal for display upon conventional reproducing system 22.

The operation of the system will now be described. A programming signal 12, such as a signal from a video or audio program from channel selector 16 or playback system 18, e.g., prerecorded videotape, or an analog or digital video disc, containing an embedded signal representing the electronic address of an online information provider in the blanking interval or other non-displayed portion of the programming signal 12 is received by address extractor 42. From the programming signal 12, address extractor 42 detects, decodes and stores a digital address of the online information provider, if any such address is embedded therein.

If an address is successfully decoded and stored, address extractor 42 activates, through signal line 44, indicator signal generator 46. Indicator signal generator 46 then produces an indicator signal and overlays or encodes it onto a conventional program signal 36 to be displayed or transduced by conventional reproducing system 22. Alternatively, indicator signal generator 46 produces a signal on line 50 which activates a special purpose indicator, e.g., illuminating a light 24 or producing a sound on a speaker 28 of access controller 10.

If the user wants to access the online information provider, the user gives such command to access controller 10 by, for example, pushing a special button on his or her remote control device. The remote control device transmits a command signal to user interface 56 which receives the command signal. User interface 56 in turn, produces a signal which is applied to address extractor 42 to retrieve the stored address of the online information provider. Under appropriate software or hardware control, the address is transmitted via modem 54 over network 30 to an online information provider, e.g., 34c.

Once access to the online information provider has been established, access controller 10 can automatically receive digital information signals through modem 54 from the online information provider. Received information signals are operated upon by processor 58 for displaying upon conventional TV reproducing system 22 or high resolution reproducing system 40, e.g., a computer monitor or other display device. Preferably, received signals which are incapable of being directly displayed upon conventional reproducing system 22, e.g., a conventional television set, are converted by a signal converter 62 for display thereon.

Information signals received from an online information provider may be displayed as still or moving images in place of the ordinarily displayed video signal on the conventional reproducing system 22, or may be displayed as part of a “picture within picture” display in conjunction with the ordinarily displayed video signal on conventional reproducing system 22 or on the computer monitor 40 or other display device.

After access has been established, user commands received through user interface 56 are transmitted as information signals through modem 54 to the online information provider, thereby providing interactive user access with the online information provider and enabling searching for detailed information, conducting transactions, sending or posting messages to the accessed provider and any other actions that can ordinarily be conducted through an online connection.

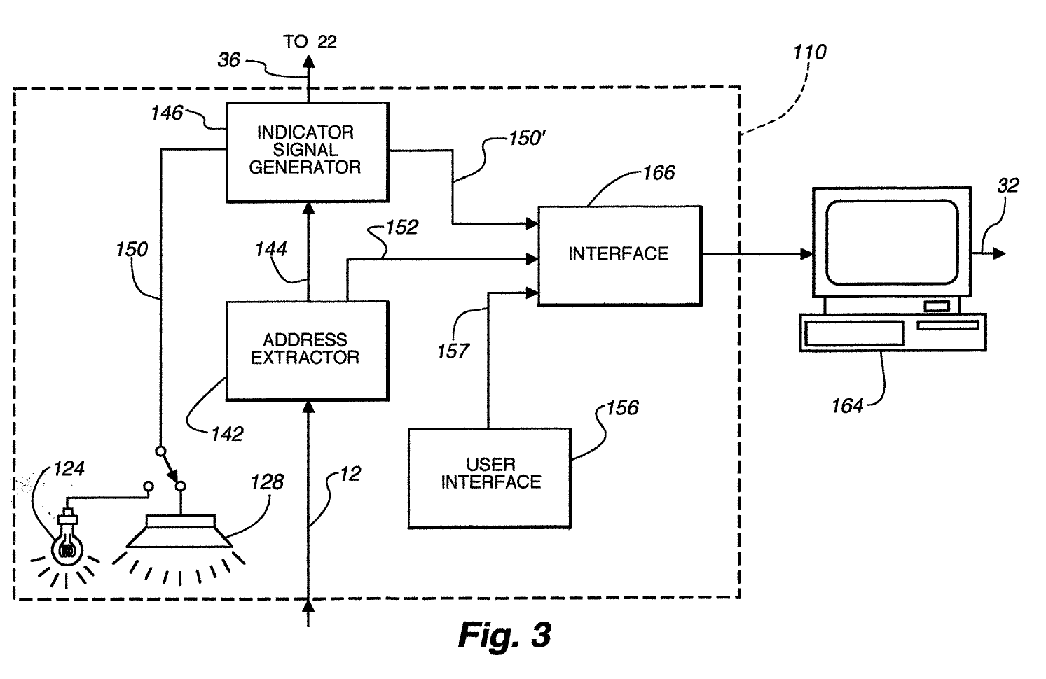

Another embodiment of the invention is illustrated in FIG. 3. FIG. 3 shows an embodiment which operates in conjunction with an available computer 164. In this embodiment, access controller 110 does not require an internal processor or modem because such functions are provided by a computer 164 attached thereto. In addition, computer 164 also provides a monitor and audio reproducing components which function as high resolution reproducing system 40. Address extractor 142, indicator signal generator 146, and user input interface 156 of access controller 110 are connected through an output interface 166 for providing decoded address output, indicator signals, and user commands, respectively, to computer 164. In other respects, access controller 110 is connected to receive a programming signal 12 and provide a conventional program signal 122 and a signal 150 to indicator 124 or indicator 128, in like manner as in the self-contained embodiment of access controller 10 described in the foregoing (FIG. 2). It will be appreciated that the computer supported embodiment of the invention (FIG. 3) provides the same function and operates in essentially the same manner as the self-contained embodiment (FIGS. 1-2) and need not be described in any further detail.

In still another embodiment of the invention, with reference to FIGS. 1-3, a connection to network 30 is maintained continuously by access controller 10 through modem 54 or the modem provided in computer 164. This embodiment will be described with reference to the access controller 10 shown in FIG. 2, although the skilled person in the art will readily understand the structural modifications required for operation in accordance with the access controller shown in FIG. 3. In this embodiment, address extractor 42 detects and decodes an online information provider address embedded in the video or audio program signal, but does not store the address.

As described in the foregoing embodiments of the invention, address extractor 42 provides a signal to indicator signal generator 46 when it successfully detects an online information provider address in the programming signal. Address extractor 42 detects and decodes the embedded address and passes it to modem 54. Modem 54, in turn, only uses the extracted address if it has first received a user command to initiate access to the online information provider. It will be appreciated that this embodiment of the invention can be used with a video or an audio program signal wherein the online information provider address is frequently or continuously transmitted. Modem 54 is provided with hardware and/or software to automatically establish, upon receiving a user command to initiate online access, a direct digital communication link with the online information provider associated with the next received online information provider address.

As an example of the operation of this non-address storing embodiment of the invention, a video or an audio program signal having a frequently transmitted embedded signal containing an online information provider address is received through line 12 by address extractor 42. Address extractor 42 detects and decodes the online information provider address, but does not store it before passing it to modem 54. Modem 54 does nothing with the online information provider address unless a user command to initiate access has first been received from user interface 56. If such user command has been received, modem 54 transmits a signal over network 30 using the next received address to establish a digital communication link with the online information provider. The function and operation of the non-address storing embodiment is otherwise the same as in the other described embodiments of the invention and need not be described in any further detail.

In yet another embodiment of the invention, automated direct user access to online information providers is achieved without incorporating an indicator signal generator 46, 146 (FIG. 3) into the access controller 10. In this embodiment, the video or audio program as produced incorporates a visual or auditory indicator, such as a logo or message, which is automatically displayed or sounded by conventional reproducing system 22 and/or high resolution reproducing system 40 during portions of the program when an online information provider address is present in the underlying electronic program signal. Through the visual or auditory indicator, the user is made aware of the availability of the online information provider address. Therefore, in this embodiment of the invention, address extractor 42 may be constructed and used in a manner so as to detect and decode an embedded online information provider address only after receiving a user command to initiate access to the online information provider.

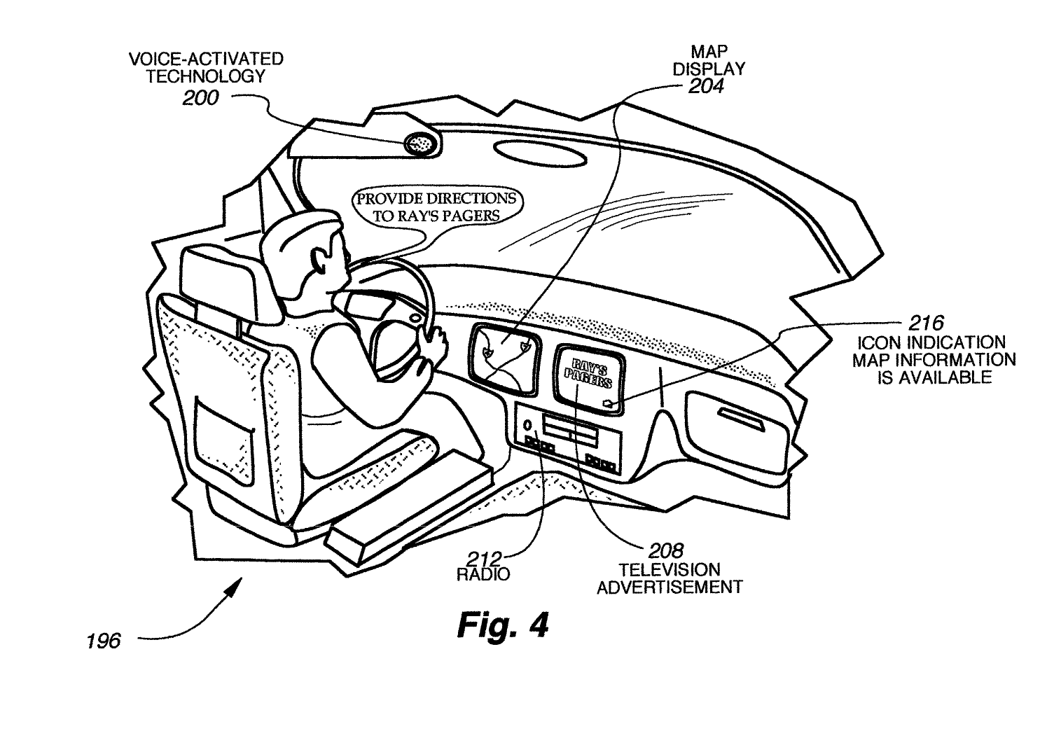

FIG. 4 illustrates a general overview of the user environment used in another system of the present invention wherein direction information is displayed to a user in a vehicle 196. In this embodiment, the direction information is content related to a programming signal, which can be received over the radio 212 or television display 208. Although the elements of the present invention are described in more detail below with respect to FIGS. 5-8, FIG. 4 presents a diagram useful for understanding the general overview of the preferred embodiment of the present invention.

In this embodiment shown in FIG. 4, an advertisement is received in the programming signal 12 at the vehicle 196. The programming signal 12, such as a signal from a video or audio program received over the air or played back from a playback system 18 (e.g., a prerecorded videotape, an analog or digital video disc, an optical or magnetic storage device, a hard disc drive, portable non-volatile memory device (e.g., a MemoryStick), portable continuously powered volatile memory device, memory cards, or a write/rewritable CDROM or DVDROM) preferably contains an address representing the electronic address of an online information provider or a representation of such address. As is commonly known, URLs are often used to represent an address for an online information provider. The present invention may utilize URLs within the programming signal 12 to represent an online information provider. However, the present invention is not limited to using URLs to represent an address. For example, any indicator, keyword, addressing scheme, trademark, or mnemonic may be used by the present invention to designate an address or a location where information related to a program may be found. For example, a McDonalds® or the golden arches trademark might be used to locate an online address for information relating to all McDonalds' restaurants, whereas McDONALDS234 might be used to address information relating to store number 234.

Additionally, the address can be embedded in the blanking interval, embedded in other non-displayed portions of the programming signal 12 or may be received independently from the programming signal by an alternative communications path. If embedded in the programming signal 12, the address extractor 42 detects, decodes and stores a digital address of the online information provider. If an address is successfully decoded and stored, address extractor 42 activates an indicator signal generator 46. Indicator signal generator 46 then produces an indicator signal and preferably overlays or encodes it as an icon 216 onto a video signal to be displayed or transduced on the video display 208. Any of the alternative indicator signals (for example, an audible sound) as described above can also be employed in this embodiment.

If the user wants to obtain direction information to a facility associated with the advertisement, the user gives such command to access controller 10 by, for example, pushing a special button on the dashboard or preferably, providing a voice command to a voice activated system installed in the vehicle. Any voice recognition system known in the art may be used with the present system. The voice activated system transmits a command signal to user interface 56 which receives the command signal. User interface 56, in turn, produces a signal which is applied to address extractor 42 to retrieve the stored address of the online information provider. Further, when available, the system determines the current position of the vehicle preferably using a GPS system.

In an alternative embodiment of the present invention, the access controller 10 is conFIG.d such that the address of the online information provider is automatically accessed without requiring the user to enter or give a command to a system implementing the present invention. As such, the present invention may be conFIG.d such that whenever an address is provided with a programming signal, the system automatically pushes information, including directions (when GPS information is available) and/or location information, to the user.

Similarly, the present invention may be conFIG.d such that directions and/or location information are automatically pushed to a user based upon a user profile. The user profile may include any variable/parameter that indicates how, where, when, what, and in which format(s) a user desires to receive information associated with an address in a programming signal. The user profile information might indicate, for example, that a user prefers to receive information only when the user's vehicle is not moving. Similarly, the profile might indicate that the user does not desire to receive information on certain restaurants or types of restaurants, or that the user only desires to receive information on locations within 2 miles of a current location or a home location, or based upon any other preference. The user profile may also take into consideration variables such as age, gender, income, type of vehicle driven, time of day, location of vehicle, and past responses to indicator signals.

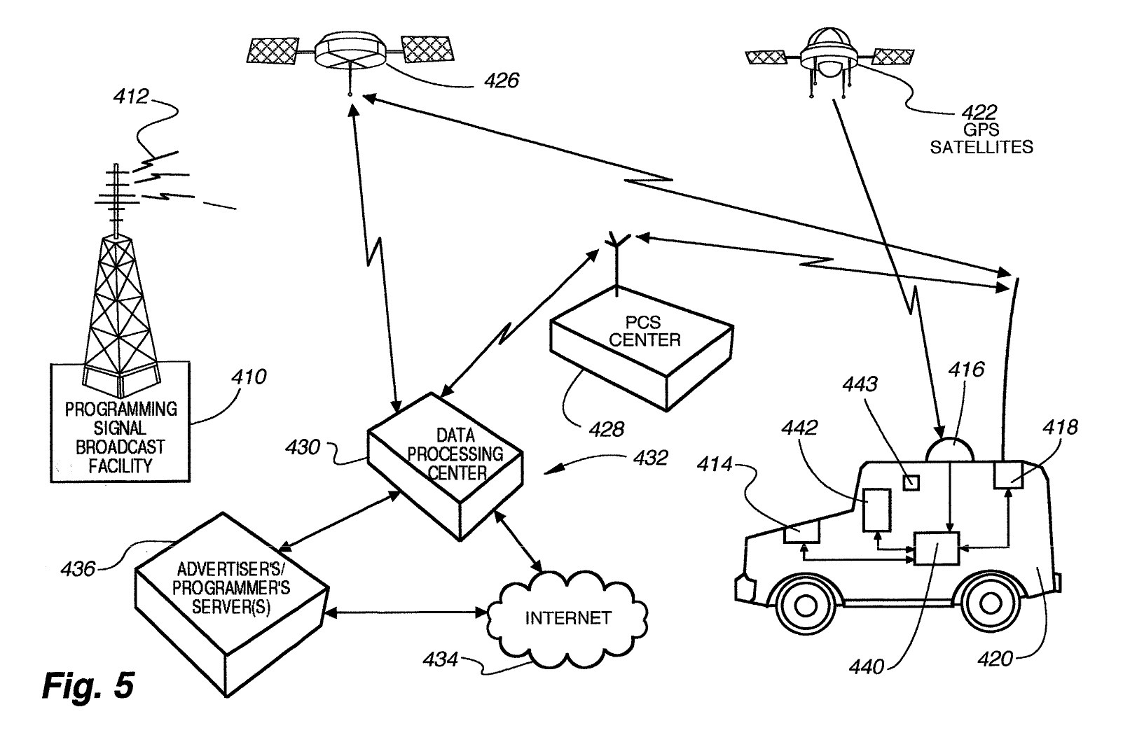

Once the GPS location data (when available) is determined, the GPS location data and the address are combined in a signal and transmitted preferably over a wireless connection to a data processing center, described in more detail below in reference to FIG. 5. When GPS data is not available the other data (such as user preferences) and the address are combined and communicated to the data processing center. Once access to the online information provider has been established, the vehicle can automatically receive digital information signals including address/map directions (when GPS data is available) from the data processing center and online information provider or other information, for example, a sample menu for a McDonalds restaurant. Received information signals are preferably displayed on the map display device 204 or alternatively may replace the advertising program on the video display device 208.

Thus, information signals containing directions received from an online information provider may be displayed as still or moving images in place of the ordinarily displayed video signal on the video display device 208. These signals may also be displayed as part of a “picture within picture” display in conjunction with the ordinarily displayed video signal on conventional reproducing system 22 or on the computer monitor 40 or other display device set up in the vehicle (not shown in FIG. 4).

In an alternative embodiment, instead of transmitting the GPS location data and the address for the online information provider in a combined signal, a voice and/or data telecommunications link is established with an operator at the data processing center. In this embodiment, the user suitably communicates the address, their location (for example, when available, by reading the GPS location information from a display device), and any other pertinent information to an operator or customer service representative. The customer service representative then accesses the appropriate databases and provides the requested information to the user as a verbal communication, as a programming signal, or as a combination thereof. In this manner, the present invention may be conFIG.d to support users of varying levels of technical sophistication, while providing customer support services as desired. Those skilled in the art appreciate the various other permutations of data, address, location information and other communications between a data processing center (with or without an operator) and a user which are possible in light of the present invention. In short, the present invention covers any systems and methods for communicating an address received in a programming signal and, when available, location information for a user to a data processing center, receiving destination and other information responsive to such request, and expediting transactions for goods/services between a user and a provider by utilizing MOTES.

After access has been established, user commands received through user interface 56 are transmitted as information signals through modem 54 to the online information provider, thereby providing interactive user access with the online information provider and enabling searching for additional detailed information, conducting transactions, sending or posting messages to the accessed provider and any other actions that can ordinarily be conducted through an online connection.

FIG. 5 illustrates an embodiment of a system of the present invention for providing the invention described with respect to FIG. 4. In the embodiment of FIG. 5, an (optional) GPS receiver 416 in conjunction with an access controller 440 is situated in a vehicle 196 to provide directions to a location. The location is associated with the content of the programming signal. The location is identified through the online address. As shown, the vehicle 420, in addition to the access controller 440, includes a programming signal receiver 414, an (optional) GPS signal receiver 416, a wireless communications system 418, and a user interface 442. Each of these units are in communication with the access controller 440. It is to be appreciated, however, that the GPS and/or other location determination systems may not be included in the present invention such that directions, if any, are not based upon such automatically determined location information.

The system, shown in FIG. 5, however, preferably uses GPS signals transmitted from GPS satellites 422 and from differential GPS centers 424 to determine the location of the 20 vehicle. Various communication links may also be utilized including satellite communication links 426, cellular/digital/PCS networks 428, and any other communications links known in the art to facilitate communications between the vehicle and network 432. In the preferred embodiment, a PCS digital network is utilized for accessing the data processing center 430. Such communications links are preferably established between a data processor/server 430 or via the Internet 434 with a server 436 specified by an online address embedded in the programming signal. Of course, the online address could be received, separate from the programming signal, via any communications links known in the art. For example, the address could be received via control channels in a PCS or cellular network.

While this embodiment is described with reference to a vehicle, it is to be appreciated that various combinations of the access controller 440, receivers 414, GPS system 416, user interface 442, display(s) and communication links 418 may be provided in any device including a hand-held device (such as a Palm device or other Personal Data Assistant (PDA)) and/or a backpack unit. Further, as specified above in conjunction with the various other embodiments, the programming signal 412 may be an audio, video or combined signal and is not limited to a radio broadcast signal.

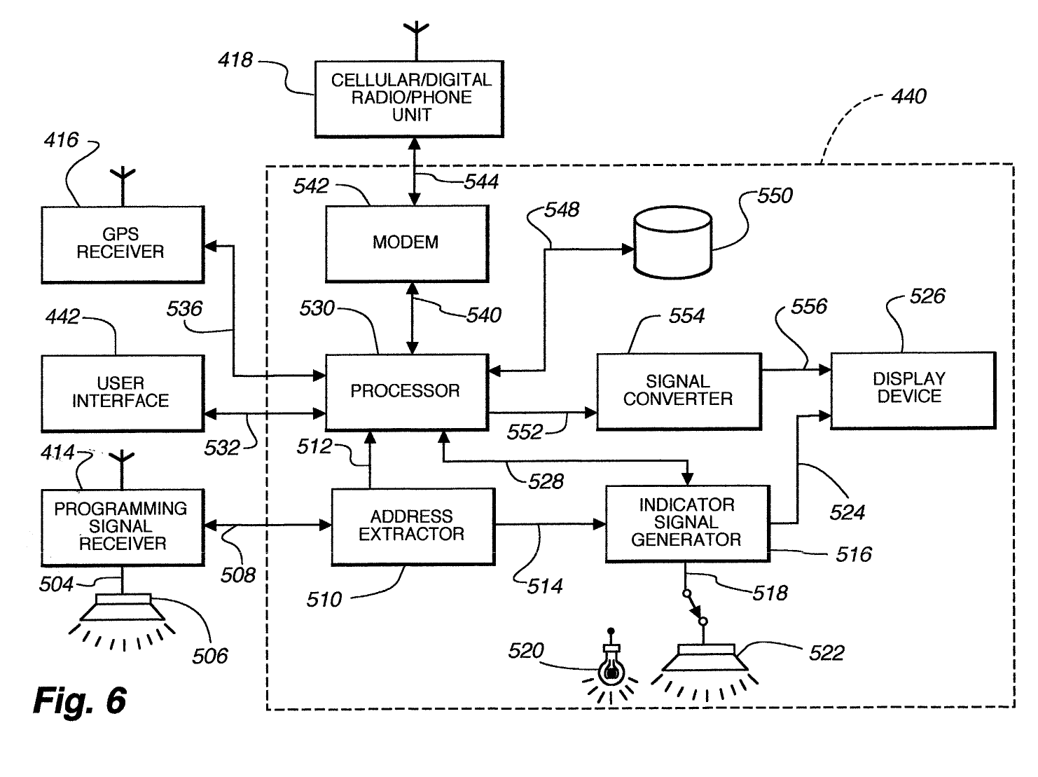

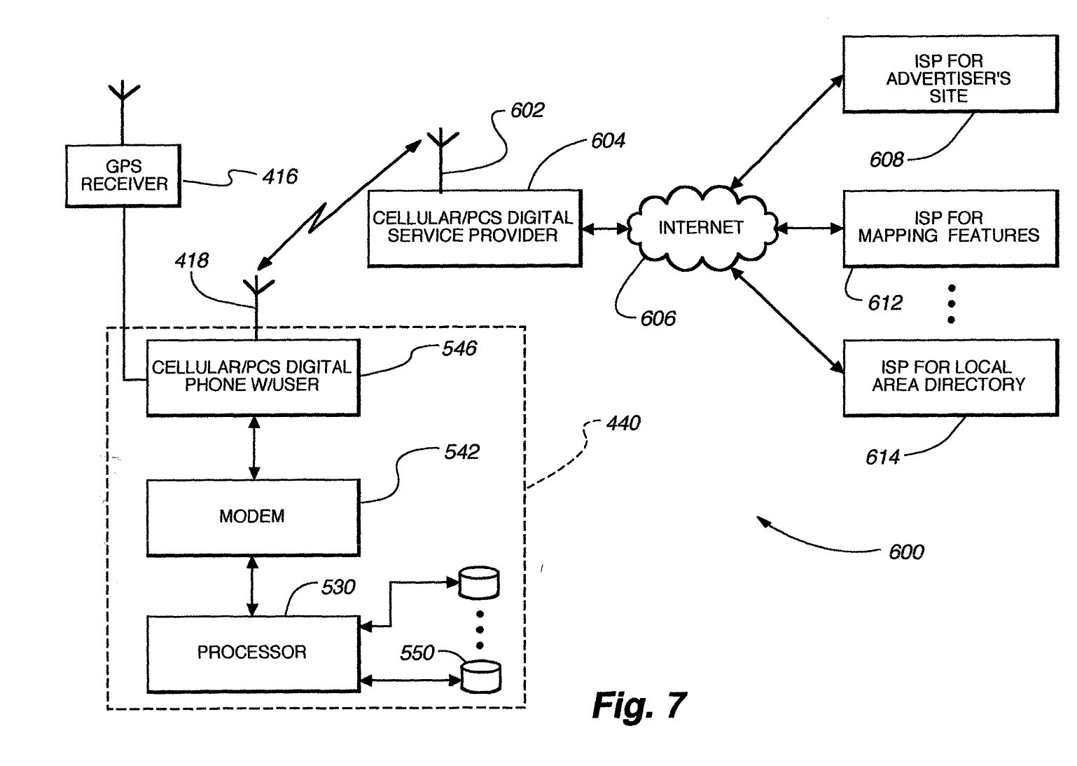

Referring now to FIG. 6, a preferred embodiment of an access system 440 is shown in more detail. As previously mentioned, the access system 440 is connected to a programming signal receiver 414 which is connected via link 504 to a display unit 506 (in this case, a speaker system). The display unit 506 may be any unit capable of presenting a programming signal and mapping or other direction information to a user including, but not limited to, speakers, headphones, and video monitors. Those skilled in the art appreciate that various forms of video monitors may be utilized including, but not limited to, flat screen displays, Light Emitting Diode (LED) displays, conventional cathode ray tube displays, and Heads Up Display (HUD) units. For example, a HUD unit may be installed on a dashboard such that information is presented on the windshield to the driver/user. Further, the display unit may comprise multiple display monitors, for example, one for showing the programming signal and one for presenting the map or other direction information. Alternatively, the mapping or other direction information may be shown in a picture-in-picture arrangement or side-by-side arrangement, as commonly known in the art, with the program carried in a video programming signal. Further, combinations of audio and video signals may be utilized, for example, a radio program may be presented over a sound system while directions to a location are provided on a display device attached to, or separate from, the sound reproducing system. Audio systems, especially those for vehicles, which incorporate video systems for providing directions are well known in the art.

The program receiver 414 is connected via link 508 to an address extractor 510. The address extractor receives the programming signal from the receiver 414, detects an address embedded therein, extracts the address, decodes the address, and stores the address for later use by the processor 530. As described herein in conjunction with the various other embodiments, the address extractor 510 may utilize various methods for extracting an address from a programming signal.

The address extractor 510 preferably has an output connection 514 with an indicator signal generator 516. The indicator signal generator 516 notifies the user that more information relating to the program is available and more specifically, that directions can be provided to a destination associated with or related to the program. The information and/or directions are preferably accessible from an electronic database (which is preferably nonvolatile) after address extractor 510 has decoded and identified such address from the programming signal. The indicator signal generator 516 causes, for example, a video image (e.g., picture within picture, logo, or icon) to be displayed on the user interface 442. In this embodiment, the indicator signal generator 526 also provides an output signal on link 524 to a display device 526, if desired. The display device 526 may be the same device as provided by the user interface 442 or a separate device. The design of indicator signal generator 516 is well known in the art.

For systems without video capabilities, the indicator signal may be an audible sound generated via a speaker 522 or it may consist of a steady or blinking light 520, a vibrating car seat (when the system is used in conjunction with a vehicle), or a vibrating device (similar to the vibrations often provided by a pager). In short, any system and/or method capable of indicating to a user that additional information is available may be utilized by the present invention. While the indicator signal is a preferred element of the present invention, its use is not necessary.

The access system 440 also has a link 512 from the address extractor 510 to a processor 530. The processor 530 may be any general purpose processor programmed and/or conFIG.d to provide the various features and functions of the present invention. Additionally, the processor 530 is conFIG.d to process the programming signal, information signal, and indicator signal, as necessary. Further, the access system 440 is preferably conFIG.d such that the processor 530 controls, manipulates, and/or performs the various features and functions of the access system 440 including extracting signals, determining positional data (when such position determination systems and signals are available), and providing communications features.

As further shown in FIG. 6, the processor 530 operates as the central hub for routing and controlling the various signals. The processor 530 is connected to the user interface 442 by link 532, through which a user inputs selections. Upon selecting additional information (such as a map), the processor 530 establishes a communications link with an online information provider identified by the address embedded in or associated with the programming signal 412.

It is to be appreciated that many conventional input interfaces are well suited for use as an user interface 442. As shown in FIG. 4, preferably the user interface 442 includes a speech recognition unit which allows a user to verbalize commands to the processor 530 while not having to remove their hands from the steering wheel. The speech recognition unit may also operate as a voice trigger. Such speech recognition units are well known in the art. However, any user interface may be utilized in the present invention including microcomputer interfaces such as a mouse, touch pad, touch screen, trackball, joystick, pushbutton, eraser head, and keyboard. The user interface is preferably positioned in a location convenient for a user. For example, a pushbutton may be positioned in a vehicle on a steering wheel, on a dashboard, in a center counsel, on the seat, etc. The present invention suitably accommodates any system or configuration desired by a user.

Similarly, infrared, radio, and audio frequency interfaces which decode a single key or multiple key sequence input from a wired or wireless control panel may be utilized. In such an embodiment, the user interface 442 detects when a special purpose button on the interface 442 has been pressed and provides a responsive signal which automatically causes the processor 530 to obtain the address from the address extractor 510 and establish a communications link with an online information provider. The interface 442 may also be constructed to detect when a special sequence of keys has been pressed on a conventional control unit (e.g., a sequence such as “ENTER” “ENTER” “+VOLUME”).

In order to facilitate accurate mapping, the access system 440 is preferably in communication with a GPS receiver 416. GPS receivers are commonly available and well known in the art. The present invention preferably utilizes any such GPS system. However, alternative embodiments which do not use location determination systems, such as GPS receivers, are also considered to be within the scope of the present invention. As shown in FIG. 5 for the preferred embodiment, the processor 530 receives via a data link 536 position signals from the GPS receiver 416. The position signals may be generated by the GPS receiver 416 in formats suitable for immediate processing or they may be translated, as necessary, by the processor 530. The GPS receiver 416 preferably provides real-time position determinations for the access system 500. While the present invention preferably utilizes GPS systems to provide accurate positional information, the present invention may be conFIG.d to utilize various other positional determination systems and approaches, including: Distance Measuring Equipment (DME) based on signal transmissions and radials including time changes, frequency changes, and other measurement techniques; Loran; triangulation of radio frequencies from known transmitter locations; intersections of two radio frequencies coupled with radials; and various methods for locating a 911 caller from a cellular phone. These various methods of determining the location of the vehicle may be accomplished within the vehicle (by performing the necessary calculations in the access controller or a similar component) or by establishing a communications link with a remote processing center which provides the current location of the vehicle. Additionally, the present invention may also be conFIG.d to combine the signals from multiple position/location determination systems in order to achieve a more precise location determination or for any other purpose. Those skilled in the art appreciate the various connections, hardware, and system components necessary to combine multiple position signals into a final position determination.

The access system 440 is also provided with a modem 542 connected via a data link 540 with the processor 530. The modem 542 facilitates the transmitting and receiving of digital signals between the processor 530 and the data processing center 430 (FIG. 5) preferably via a wireless telecommunications unit 418. The modem 542 converts the incoming digital signals into a format suitable for the processor 530 which then extracts a video and/or an audio signal (for example, a video representation of a map or audible directions). The access system 440 preferably includes a signal converter 554 for adjusting or converting an incompatible signal for display/presentation upon the display device 526. As mentioned previously, the display device 526 may be any device capable of communicating information to a user. Such a device could include a printer for printing maps or directions.

The access system 440 also includes a data storage device 550 for storing instructions and other information. The data storage device 550 may include Random Access Memory (RAM), Read Only Memory (ROM), permanent storage devices (for example, CDs and DVDs), and temporary storage devices (such as hard-drives). Further, portable non-volatile storage devices and/or portable continuously powered volatile storage devices may also be 10 utilized. Similarly, the present invention may be conFIG.d without data storage devices by hard-wiring circuits, providing internal registers, or utilizing off-site storage devices (for example, storage provided at the data processing center 430, FIG. 5).

Referring again to FIG. 5, in one embodiment of the present invention, connectivity between the user and the advertisers/programmers servers 436 (i.e., the information providers) is established via the data processing center 430. In addition to those features commonly provided by a data processing center (for example, file backup and data routing), the center 430 provides those data processing features necessary to determine from which online information provider content (for example, maps and directions) should be requested based upon the last reported location of the user. The center 430 also establishes communications links via the Internet 434 or other communications links 435 preferably with an Internet Service Provider (ISP) hosting a web site identified by the address transmitted in conjunction with the programming signal 12. Commonly known Internet protocols are utilized to connect with such ISPs or proprietary nets. Additionally, the center 430 may be conFIG.d to establish communications link via public and/or private networks and connections. Throughout this specification of the present invention, the drawing FIG.s, and the claims herein, wherever reasonable, references to the Internet shall be interpreted to include various other network and communications connectivity configurations including, but not limited to, private networks (for example, Intranets, AOL and OnStarD), public networks and various others.

The center 430 may also establish communications links with other databases, ISPs, and Application Software Providers providing application specific software packages, for example MAPQUEST or any other online information provider contacted via a public or private connection. The center 430 preferably receives data from the advertiser/programmer related to the selected address and data from the access system 400 (including position data), processes the data, provides a query to MAPQUEST or a similar direction determination program and obtains directions and/or maps to a specific location (for example, one of an advertiser's numerous facilities). These directions are translated by the center 430 into a format suitable for transmission back to the access system 440 which then provides such directions/maps to the user. Thus, in this embodiment, the center 430 performs the majority of the data interpreting, routing, querying, and processing features necessary to determine directions in response to an address provided with a programming signal 12. The access controller 440 primarily functions as a conduit of information between the user and the center 430. It is to be appreciated, however, that data processing features described herein may be distributed between the access controller 440, the center 430, or the advertiser's/programmer's server 436, as desired.

FIG. 7 depicts another embodiment of a system of the present invention. In this embodiment, the access system 440 performs many of the data manipulation and processing features performed by the center 430 in the previous embodiment. In this embodiment, the access system 440 establishes a direct communications link through a wireless service provider 604 and the Internet 606 with an ISP 608 hosting an advertisers/programmers online information. As such, the access system 440 provides the data requesting, processing, storing and manipulation functions performed by the data processing center 430 in the previous embodiment. Those skilled in the art appreciate that the processor 530 needed to provide the functions and features of the data processing center 430 may require greater operating speeds and performance characteristics than a processor which primarily acts as a conduit of information. Various processors currently exist which can provide the desired performance characteristics for the various embodiments. Any suitable processor may be utilized by the present invention.

Similarly, in a third embodiment (not shown in any FIG.), the access system 440 periodically retrieves data from advertisers/programmers via the Internet. The data retrieved preferably contains the content referenced by an address embedded within the programming signal. The content is stored in a storage device 550 (FIG. 6) provided within the access system 440. Similar to the other embodiments described above, the user system continues to receive a programming signal 12 via any transmission means. Additionally, mapping software and other information/programs necessary to provide directions to a user are stored (or hard coded) in the access system 440. As such, when a user commands the access system 440 to generate maps and/or directions, in response to an address, the access system 440 does not have to establish communications links with external online information providers in order to process the user's request. Instead, the address is routed by the access controller 440, via the processor 530, to the appropriate data files in the storage device 550. The address may be translated by the processor 530, as necessary, and/or the files structures in the storage device 550 organized such that a single address format is compatible with any embodiment of the present invention.

Additionally, instead of receiving a programming signal 12, the present invention may be conFIG.d such that a virtual radio/television station is provided. Virtual stations are currently provided by online information providers such as AMERICA ON-LINE® and YAHOO!® Additionally, virtual stations may be provided by combining high density storage devices such as TiVo® with information downloads from an online information provider of a program, which is then presented to the user at the desired time. For example, a broadcast of a concert might be downloaded from an online information provider and stored on a TiVo, or similar, storage medium. The virtual program may include commercials, indicators and various other promotional devices which are designed to notify a user of goods/services for sale and when the user is in the proximity of a restaurant, a retail establishment, or a similar location being marketed based upon the current location of the user, as determined by GPS or a similar system.

In a fourth embodiment (not shown), the access system 440 further includes media playback devices such as Digital Versatile Disc (DVD) players and CD-ROM players. In this embodiment, the selected address specifies content contained on the recorded media (DVDs/CD ROMs) which the processor 530 suitably identifies and retrieves. Communications links with ISPs or data processing centers are not routinely established in this embodiment. Instead, all of the information required to provide directions in response to an address is provided in the DVDs, CDs, and other memory device utilized in communication with the access system 440. Further, the programming signal itself may be prerecorded on and thereby played back from local storage.

In another embodiment of the present invention, a user is provided with the opportunity to purchase goods/services indicated during a programming signal by “clicking” or suitably directing the access controller 42 to transmit a purchase order to a location nearest to the user's current position, as determined by the GPS system, or another location (for example, when a GPS equipped system is not available). For example, when a user is presented with an advertisement for a special on a product at K-Mart®, the user may transmit an order for such product by a simple “click” or push of a button on the user interface 56. The present system, then utilizes the user's current location and the online information provider to determine the nearest K-Mart's location. The present invention then establishes a communications link with a system accepting orders for the designated K-Mart, orders the product being advertised, and provides directions from the user's current location to the designated K-Mart. Similarly, the system may be conFIG.d such that when user location information is not available, the purchase request can be processed and the user can then proceed to a location compatible with the MOTES systems such that upon arrival at the retail location, the location receives the MOTES information and expeditiously processes the request.

Similarly, the address information for the vehicle 196 could also be utilized to identify local specials for establishments being marketed in the programming signal 12. These local specials could be identified by establishing a communications link with an online information provider or by accessing a remote or local database.

While the present invention has been described in the context of various embodiments utilizing various connectivity schemes with ISPs, data storage devices, and data processing centers, it is to be appreciated that the present invention is not limited to any specific operating theory, system embodiment, hardware configuration, or communications network. For the preferred embodiment, any system which provides for the combination of GPS or other position/location data with an address provided in conjunction with a programming signal is considered to be within the scope of the present invention. However, systems not equipped with location determination capabilities are also considered to be within the scope of the present invention. Additionally, the present invention is preferably conFIG.d to receive and process streamed audio, video and other data. However, the present invention may be utilized in conjunction with streamed data and/or non-streamed data, and is not to be construed as being limited to any specific signal format or transmission medium.

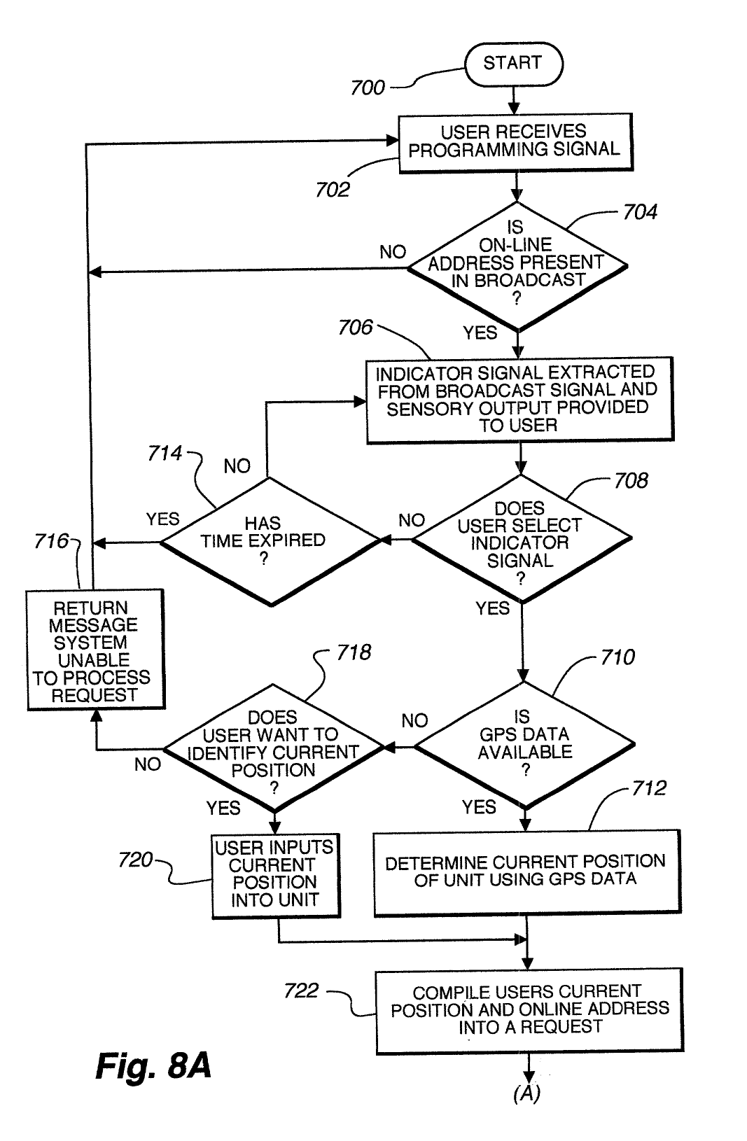

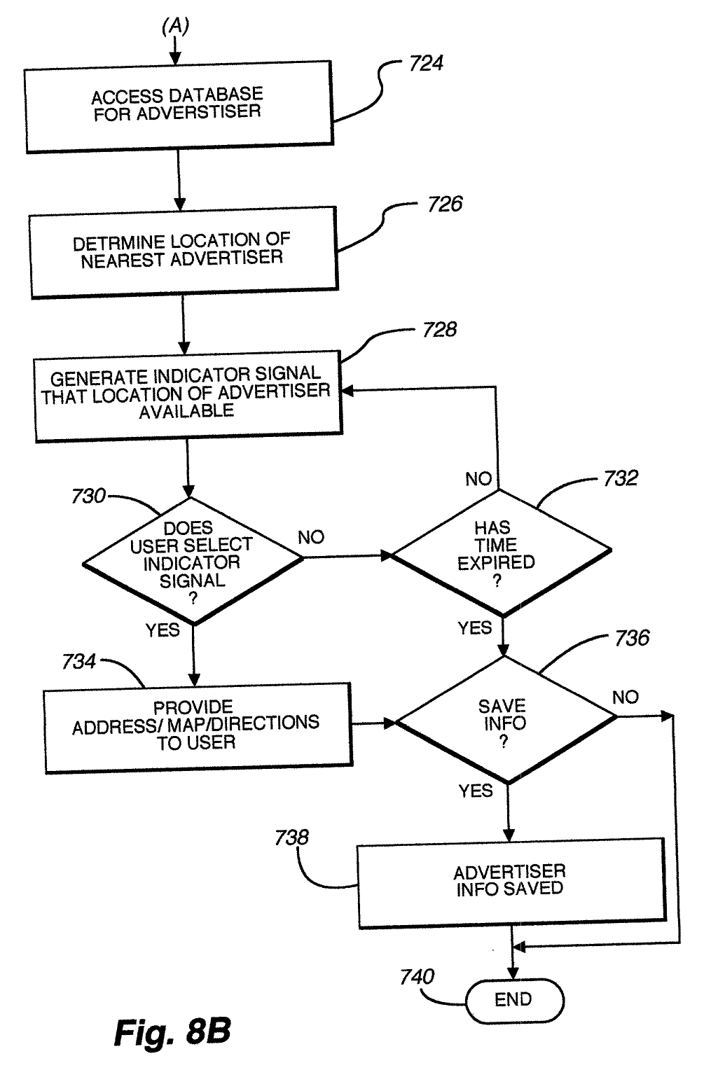

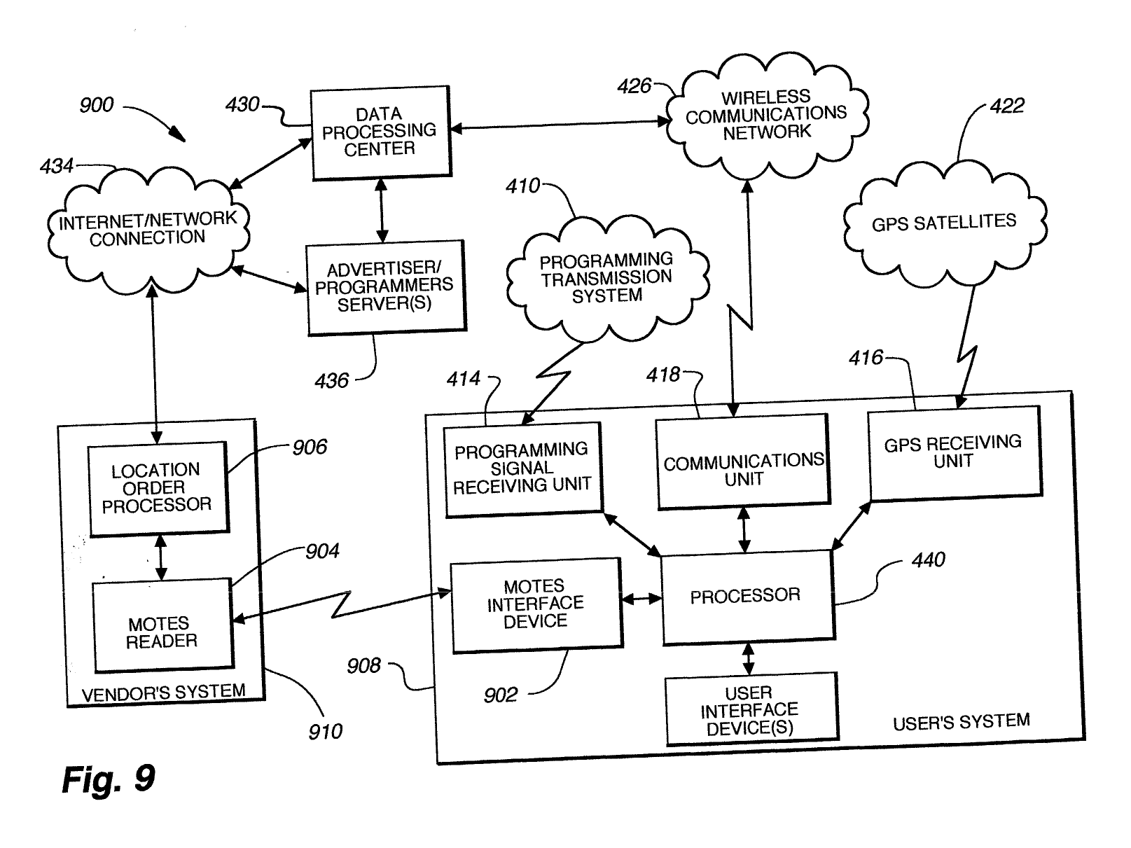

The operation of the system will now be described with reference to an exemplary process flow as shown in FIG. 8 and the various system components shown in the previous embodiments. A programming signal 412 preferably containing an embedded information signal is transmitted by a broadcaster 410, or received from a pre-recorded media (a DVD, digital tape, CD ROM, TiVo storage device, virtual radio/television station, or the like), whether local or remote from the user. An address preferably representing the location of an online information provider is embedded in, or transmitted separately from, the programming signal. If the address is not embedded in the programming signal, it may be sent in a data channel from the same transmission means of the programming signal or may even be received over an alternative transmission means, such as a PCS or cellular network. The address is preferably transmitted such that it is not displayed and does not interfere with the presentation of the program (as represented in FIG. 8 by “START”, Block 700). The user receives the programming signal from either a remote or local source (Block 702). Reception of the programming signal may be by any system capable of receiving and translating the programming signal, as commonly known in the art. Such systems include radios, specialized wireless devices with display capabilities, a personal data assistant (PDA), televisions and computers. For purposes of this explanation only, such programming signal is a radio broadcast signal (either analog or digital).

After receiving the programming signal, the signal is provided to the address extractor which determines whether an address is present in, or has been communicated in conjunction with, the programming signal (Block 704). When an address is present in the programming signal 412, the address extractor 510 detects, decodes and stores the address. The storage of the address may be accomplished in the storage device 550, in memory contained within the address extractor 510, or in any other storage device. If the address is received separately from the programming signal, it is received by a conventional receiver module consistent with the particular transmission means or playback module utilized.

When an address is successfully received, detected, decoded and/or stored, the address extractor 510 activates the indicator signal generator 516 (Block 706). The indicator signal generator 516 then produces an indicator signal. The indicator signal may be presented to the user via a separate signaling device (for example, a speaker 522 or light 520), may be overlaid with the presented program (for example, by providing an audible sound over the speaker system 506), or displayed on another display device 526 (for example, a HUD unit or a video monitor).

If the user wants to access an online information provider identified by the address, the user gives a command to the access controller 510, for example, by pushing a special button located on a dashboard, a steering wheel, or any other device/location (Block 708), or by issuing a predetermined voice command known by a voice recognition system. The access system 440 preferably provides a time window within which the user may select an indicator signal. This feature may be desirable in certain applications, such as, when driving a vehicle in heavy traffic. If the user does not push the button or provide any other trigger signal, such as speaking the appropriate voice command, within a designated time (Block 714), the access system deactivates the indicator signal and resumes normal operations (i.e., awaits the reception of the next information signal while presenting the programming signal). Alternatively, the indicator system is not necessary for the present invention. In this case, it is presumed that online information is available for the program and the user can activate the online information via the user interface, as described above.

As mentioned previously, the present invention also supports the automatic pushing of information to users in response to an address being received in a programming signal. The present invention when conFIG.d to push data preferably generates an indicator signal (to notify the user of the available information) but does not require a user response/command before such data is provided. It is to be appreciated that the present invention may also be conFIG.d such that only certain types of data is pushed to a user based upon the type of data, the user's desires, a user profile, or directions provided by a transmitter of the data. For example, by suitably designating an address within a programming signal, such as an Emergency Broadcast Signal (EBS), the present invention might be conFIG.d such that such the EBS is automatically transmitted to all users or to only those users within a certain local. Such a system would be highly beneficial, for example, in tornado prone areas to warn motorists of an approaching storm and directing them to the nearest shelter.

Referring again to FIG. 8, when the user selects the indicator signal and thereby commands the access controller 440 to establish a communications link with the online information (or in the case of the stand-a-lone unit, recall the information from a local data storage device), the system (via the processor 530) determines whether GPS or other positioning data is available, as discussed previously above (Block 710). If GPS or other position data is not available (or the system is not equipped with a GPS receiver or other location determination device), the access system 440 queries whether the user desires to identify their current location, if possible (Block 718). If the user does not or can not identify their current location, the access system 440, for the preferred embodiment, sends an error message to the user and terminates the session. For alternative embodiments, the access system 440 may be conFIG.d to continue processing, as shown in FIG. 8, without any location data available.

When the user can identify their position, the user inputs such information into the system (Block 720). The user may input such information (in addition to providing any other inputs and/or commands to the system) by any manner possible including, but not limited to, key pad entries, voice entries, and touch screen entries. In the preferred embodiment, when GPS data is not available, the user verbally enters an intersection (for example, N. Broadway and Colfax). However, other location designators such as DME, Loran, 911 cellular position determinations, street addresses, landmarks, zip codes, and map grid coordinates may be utilized.

If GPS data is available, the access system 440 obtains such position data from the GPS receiver 416 (Block 712). The GPS receiver 416 may preferably be set for varying levels of precision. As is commonly known, determining one's position solely based upon signals from GPS satellites is often accurate to only within a few meters. For most applications of the present invention, such precision is more than adequate. However, when greater precision is required, the present invention may be conFIG.d to utilize differential GPS signals, and other compensation techniques, all of which are commonly known in the art.

Upon receiving GPS position data, other position data and/or user inputted position data, for the preferred embodiment, the access system 440 preferably compiles the position data and the address into a composite signal suitable for transmission to a data processing center (Block 722). This compilation generally occurs when the system is conFIG.d to operate in conjunction with a data processing center. When the system is conFIG.d to independently determine directions, such compilation may not be necessary. Instead, only the address may need to be communicated, if at all, via a web browser.

Continuing with the preferred embodiment described above, wherein the access system 440 contacts a data processing center 430, the compiled signal transmission (from the access system 440) is received by the data processing center 430. The data processing center 430 extracts the address of the online information provider from the compiled signal and establishes a communications link (generally, via the Internet) with the online information provider 436 (Block 724). At this point, the data processing center 430 downloads a listing of locations identified by the online information provider as corresponding to the radio signal within which the address was embedded (i.e., the radio advertisement or program feature). The present invention supports streamed data as well as non-streamed data. In certain situations, streamed data is desired, whereas in other situations non-streamed data is desired. The present invention may be conFIG.d to support both data types, as desired.

Using the files downloaded from the online information provider, the data processing center 430 determines the location of the nearest facility corresponding to the online information provider (Block 726), when user location data is available. The data processing center determines the nearest location by comparing the advertiser's facilities with the user's last reported location. When the user is rapidly changing locations (for example, when traveling on a freeway), the access system 440 preferably periodically provides positional updates to the data processing center 430, as necessary. Alternatively, the system may be conFIG.d to display directional information with each advertisement, such that a user may select an advertisement at any time for directions.

For example, while traveling in a vehicle, a user may receive a radio advertisement for McDonalds®. The advertisement, a programming signal, preferably includes an address which suitably identifies a location from which information pertaining to locations of McDonalds restaurants may be obtained. A system implementing the present invention, is preferably conFIG.d to automatically push location information to a user upon the receipt of an address within the programming signal. Additionally, the advertisement preferably includes a phrase such as “there is a McDonalds located near you.” The present invention is preferably conFIG.d such that directions are automatically generated in response to the phrase. Such directions might include a map or a verbal message such as, “proceed North for two blocks to the McDonalds located on your right.”

Additionally, various techniques and methods may be utilized for determining the nearest location of a facility being advertised. Such techniques may include zip code comparisons, and latitude/longitude measurements and comparisons. The present invention is not limited to any particular methodology or process for determining a user's location and/or the nearest location for a facility associated with an address present in the programming signal.

Similarly, the present invention may be conFIG.d to generate advertisements based upon the user's current location. In this embodiment, the user's location is provided to a data processing center which suitably transmits advertisements for establishments within a given proximity of the user's current location. However, should the user not want a centralized processing center to know where the user is at any time, the advertisements might also be generated from a local database.

Once the nearest location has been determined, the data processing center 430 communicates such information back to the access system 440. Preferably, the data processing center 430 communicates sufficient information (including maps, locations and directions) such that the telecommunications link may be terminated and repeated telecommunications links need not be established, thereby minimizing power needs and “airtime” connection fees. However, the system may be conFIG.d such that telecommunications links (including Internet links) are continually established, if so desired. As such, both streamed and non-streamed data transmissions are supported by the present invention.

Once the access system 440 determines or receives from the data processing center 430 the location of the nearest advertiser's/programmer's facility, the system generates an indicator signal which notifies the user that location information is available (Block 728). The user may then select the indicator signal and thereby instruct the access system to provide the instructions, directions and maps (in the preferred embodiment, the user may select the format in which the information is to be presented) (Block 730). If the user does not select the indicator signal within a prescribed time period (Block 732), the system may then either save the information or discard it (Block 736). The system preferably allows a user to save the information for later retrieval, which may be especially beneficial when the user is driving in heavy traffic.

When the user selects the indicator signal, the system provides the requested information in the format designated by the user (when multiple formats are possible) (Block 734). The system, when so conFIG.d, may then provide point-to-point driving directions, for example using a HUD unit or a video monitor to display arrows designating where to turn. Similarly, the system may be conFIG.d to provide verbal driving instructions, for example, “Turn Right at the Next Intersection.” As such the system may be conFIG.d to provide any level of precision desired for the navigation instructions. Alternatively, the system may provide the directions without the user having to respond to an indicator system. In this manner, the directions are automatically provided to the user.

In certain applications of the present invention, the user may desire to receive a listing of locations associated with the programming signal. The present invention may be conFIG.d such that instead of or in addition to generating directions to a nearest location, a listing of locations associated with the content of the programming signal is provided to the user. Similarly, the present invention may be conFIG.d such that icons and various other indicators may be utilized to identify such locations on a display or a map. For example, in response to an address associated with a McDonalds advertisement, the present invention may be conFIG.d to generate a map identifying each McDonalds restaurant within a given radius of the user's current location or within a geographical area within which the programming signal can be received. The map preferably designates each restaurant location by superimposing McDonalds golden arches “M” with a nearest location designated in bold, a different color, a larger type size, or the like. When the user selects one these locations, the present invention preferably generates directions from the user's current location (which may be determined based upon GPS location information, for example, or inputted by the user onto the map) to the selected location while also designating the selected location by superimposing a circle, for example, around the selected location. Similarly, the user's current location and heading may be suitably displayed by a direction arrow. The present invention also allows a user to save such location designations and thereby continue on a pre-planned route while retaining the location information for future reference.

The system also provides the capability for saving locations and directions (Block 736). For example, the system may save the location of the user when the user selects the indicator signal which designates that directions are available. In this manner, the system may also provide instructions to the user to enable the user to return from where they originated, thereby ensuring the user does not get lost. By storing known locations, such as home and work, in the data storage device, the present invention may also be conFIG.d to direct a user back to a known location after visiting a facility designated by the information signal. The data storage systems also enable the system to store locations of facilities in response to information signals thereby providing a database of locations which a user may access, as desired.

In yet another embodiment of the present invention, a system is provided which further enhances the capabilities of the present invention to market goods/services to users and direct users interested in such goods/services to a location providing the marketed goods/services by expediting the entry into and completion of transactions for such goods/services and the delivery thereof to a user upon arrival at a location. As shown in FIG. 9, this embodiment preferably utilizes those components previously identified for the earlier embodiments with the addition of a MOTES interface device 902 and MOTES reader 904 and a location order processor 906. For the purpose of simplicity and clarity, all of the components previously identified in the earlier embodiments are not shown in FIG. 9. It is to be appreciated, however, that this embodiment includes those display devices, user interface devices, indicator signal generators, address extractors, signal converters and other devices necessary to provide the before mentioned features and functions of the earlier embodiments.

More specifically, this embodiment builds upon the earlier embodiments by providing a system and method which allows a user to complete those transactional steps and actions necessary to expeditiously receive goods/services promoted in a programming signal and/or alternatives thereof. As shown, this embodiment includes a programming signal receiving unit 414 which preferably receives a programming signal containing an address identifying information related to the programming signal from a data processing center 430 via a programming transmission system 410. However, the system may receive the programming signal via any of the various systems and methodologies, as discussed previously with respect to the other embodiments. The system also includes a communications unit 418 which facilitates communications with the data processing center 430 or other locations (for example, a local establishment) via a suitable wireless communications network 426. In this embodiment, the wireless communications unit 418 is suitably utilized to communicate a user's requests to a location identified by the system. However, it is to be appreciated that wired networks or connections may also be utilized.

Further, this embodiment includes a GPS receiving unit 416, or similar position determination system, which determines a user's current location and facilitate the identification and providing of directions to a location associated with the address provided with the programming signal. An alternative embodiment may also be provided which does not utilize location determination systems, as discussed previously herein. The processor 440 suitably controls the operation of the system and the interfacing thereof with the user and others.

A MOTES interface device 902 is also provided with the present embodiment. The MOTES interface device 902 facilitates the identification of a user or a user's vehicle to a location without requiring the user to input a pass-code, scan a card, or perform a similar action. Upon arrival of a user at a location designated by the present invention, a MOTES reader 904 identifies the user such that the remainder of the transaction may be completed utilizing any available automated payment and billing system. The use of MOTES to identify a user and automate the payment of fees is well known in the art, and are not discussed further in detail herein. Such systems have been used for years, for example, to expedite the identification of vehicles and the payment of tolls (as provided for by an EZPass system). The present embodiment may utilize any identification and payment system which expedites the identification and payment of fees associated with an activity (i.e., a purchase of goods or services) and is not to be construed as being limited to any specific system or methodology. As such, card readers, key pads and other devices may be used alone or in conjunction with a MOTES to identify a user. Such systems may be highly desirable when the owner of a vehicle is not generally the driver or user of the vehicle. For example, rental cars equipped with a system implementing the present invention.

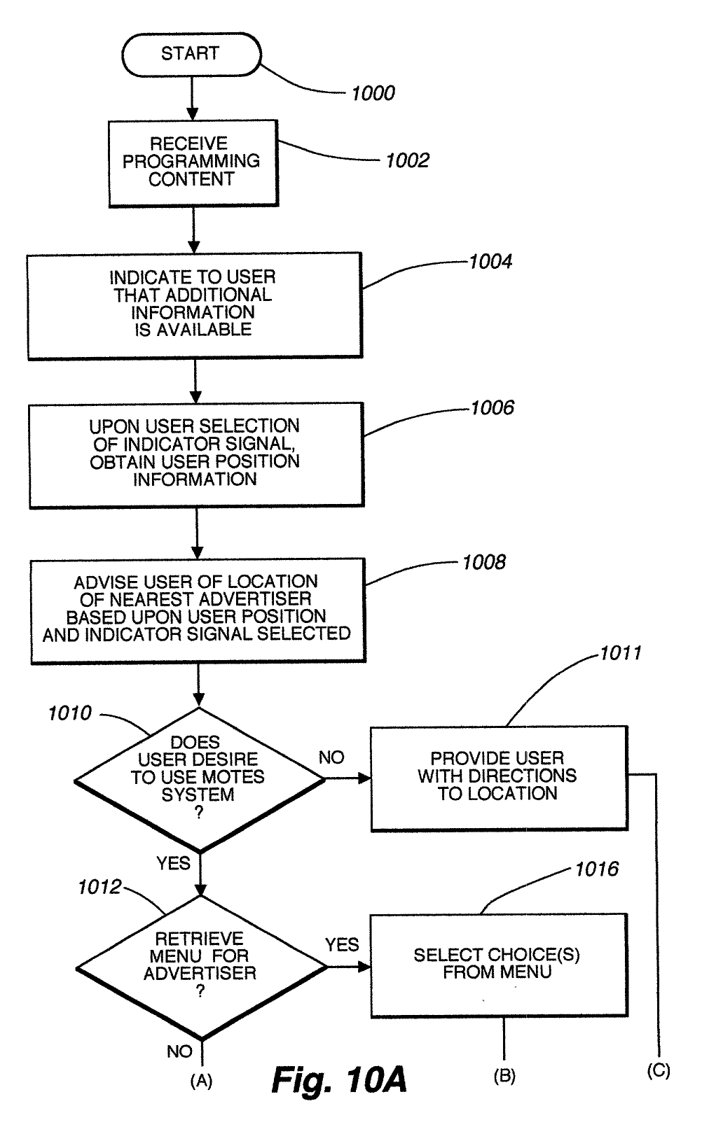

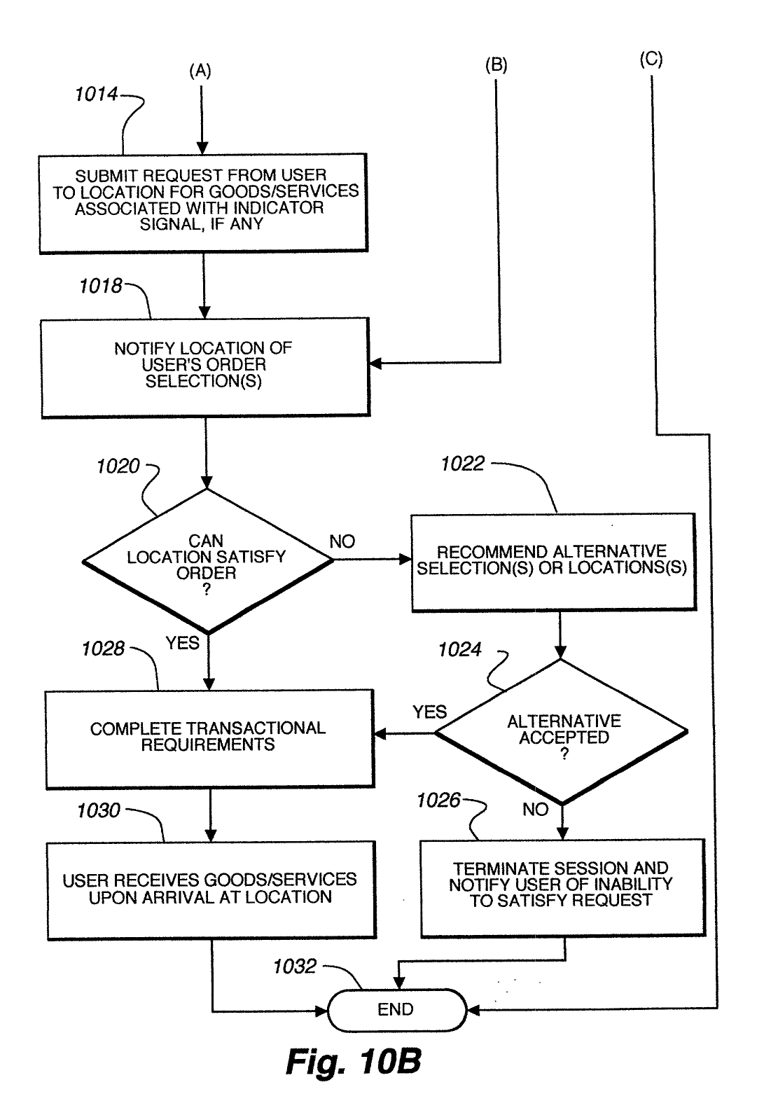

As provided for earlier herein, the present embodiment is conFIG.d to facilitate the promotion to and identification of goods/services by a user via a programming signal, and then (when suitable processing capabilities are available) providing directions to a location providing such goods/services. Additionally, the present embodiment provides a system and method which allows those ordering and transactional requirements to be accomplished prior to the arrival of a user at a designated location, and then facilitating the expeditious provisioning of such goods/services to a user upon their arrival at the designated location. FIG. 10 provides an illustrative flow of the process utilized by this embodiment to provide such features and functions.

As shown in FIG. 10, and with reference to FIG. 9, the process preferably begins when a user's unit 908 receives a programming signal containing programming content which includes an address identifying additional information (Block 1002). The user's unit 908 suitably identifies that an address is available and generates an indicator signal to the user (Block 1004). As discussed in the previous embodiments in which addresses are pushed to the user, the system may eliminate Block 1004 and proceed with automatically pushing the address or additional information to the user once the user has indicated a desire to receive such information. Thus, the present embodiment is preferably compatible with either a “push” or a “pull” system.

Upon indicating to the user or automatically pushing an address to the user, the process continues when the user selects an indicator signal. At this point, the system determines the user's position using GPS or other location determination systems (Block 1006) (when available). The system then advises the user of the nearest location (when position determination is available) associated with the selected address/indicator signal and provides directions thereto (Block 1008). As such, up to this point, the present embodiment functions in a similar manner to the previous embodiments.

At this point, the system preferably queries as to whether the user desires to utilize MOTES or a comparable system to expedite the provisioning of goods/services (Block 1010) to the user. As is clear from the previous embodiments, the submission of requests by a user to a location may be accomplished without utilizing MOTES, for example by phoning in a request. The present embodiment suitably enhances these capabilities of the previous embodiments by providing automated requesting and associated transaction processing capabilities. As shown, when a user does not desire to utilize MOTES, the system preferably provides the user with directions to the location (Block 1011) and resumes the processing identified in the earlier embodiments (i.e., providing directional updates and saving directions).

When a user desires to utilize MOTES in combination with the capabilities of the present embodiment, the process continues with querying the user as to whether they desire to access a menu or input a selection choice provided by the location or an associated data processing center (Block 1012). In short, the present embodiment preferably enables a user to select the advertised goods/services and/or alternative goods/services. For example, a user traveling by car may hear a radio commercial for McDonalds offering two for one Big Macs® and providing an address in the programming signal for identifying the nearest McDonalds location based upon the user's current location. Since the user may desire to purchase McDonalds' products, which may include the advertised special and/or other goods, the system preferably queries the user as to whether additional menu items should be presented (visually or audibly). When the user responds favorably to the query, the system then provides additional or alternative choices from which the user may select (Block 1016). Returning to the McDonalds example, such choices may be presented by displaying a menu on a video display device, or having an attendant (which may be computerized), via the wireless communications network, ask the user whether, for example, they would like to order additional items (for example, soft drinks and french fries). Thus, the present embodiment preferably enables a user to specify a complete order to a location nearest to them based upon the receipt of an address in a programming signal.

Similarly, in certain instances a user may not desire to order additional items and thus responds with a no to the query in Block 1012. In such an instance, the present embodiment preferably automatically submits a request for the goods/services marketed and associated with the address in the programming signal, since the user had previously responded favorably to using MOTES (Block 1014).

Upon entry of the user's request (either by responding to menu choices or by responding “no” to the query in Block 1012), the system continues with communicating the request to the provider or a provider designated location (Block 1018). In the preferred embodiment, the user is not required to actually communicate directly with the location, instead the system utilizes a centralized data processing center that provides those prompts and processes necessary to obtain the request from the user. In such an embodiment, it is anticipated that communications barriers (for example, language, transmission clarity, and background noise) are reduced because the request is first provided to the centralized data processing center which then suitably translates and manipulates the request before the request is communicated to the location, for example, via the Internet/network connection 434 between the data processing center 430 and the destination location 910.

Preferably, the system communicates the order to the destination location 910 in a universal language which may then be suitably converted into a local language (for example, a user who speaks English would have their language converted into German, when traveling in a predominately German speaking country). Language conversion programs and systems are well known in the art and any such system may be utilized directly or indirectly (for example, via an Internet site providing translations services) by the present embodiment. Similarly, it is to be appreciated that communications between the user's system 908 and the vendor's system 910 may be direct or indirect and that any level of operability or system functionality may be provided by the system 900 or its various elements as a whole or individually, as desired.

To illustrate the operation of the present invention in a real-world situation, assume the following scenario arises. While traveling through a city, a radio advertisement containing an embedded address is presented for Pizza Hut®. The user, desiring to purchase dinner, is interested in determining the location of the nearest Pizza Hut and picking up a pizza order via a drive thru window, without having to wait five minutes or longer for the pizza to be cooked or having to pay with cash upon arrival. Instead of traveling aimlessly through the city looking for the nearest Pizza Hut or calling information on a wireless telephone, the user, upon receipt of an indicator signal, commands the access system 440 to extract the address and establish a communications link with Pizza Hut's central order processing system. The central order processing system, which may be contacted via the Internet or otherwise, utilizes the user supplied positional information to determine the location of the nearest Pizza Hut restaurant which can process the user's order by the estimated time the user arrives. The system provides the user with a variety of menu options, including specials (which preferably will not require the user to wait upon arrival at the nearest Pizza Hut). Once the user completes ordering, the centralized order processing system suitably notifies the local establishment of the order while also obtaining payment information from the customer (which is preferably automatically accomplished using saved payment information such as a debit or credit card information). Simultaneously, the system is utilizing other databases, such as traffic and road conditions information, to determine the optimum route for the user to travel to the restaurant location fulfilling the customer's order.

Upon arrival at the restaurant, the user's vehicle is preferably identified via a signal generated by the vehicles' MOTES interface device 902 or another identifier, for example, a vehicle license plate number. The user's order is then provided to the user, preferably without delay. Thus, the present embodiment of the invention, enables a user to respond to programming, determine locations of providers of goods/services indicated in such programming, and complete transactional requirements before arriving at such location, thereby expediting the providing of goods/services to the user, while significantly enhancing the effect of such marketing efforts. In short, by combining GPS data with the convergence of online information providers and programming signals, the present invention facilitates the efficient contacting, transacting with, finding of businesses, and provisioning of goods/services by such businesses to users receiving the programming system.

While the present invention has been described in the context of a system and method for providing directions to a driver of a vehicle in response to a radio broadcast, it is to be appreciated that the present invention is not limited in its application to only a driving scenario. By merely substituting the broadcast programming signal 414 with any currently available audio/video playback systems (for example, a video cassette recorder, a compact disc player, or a digital versatile disc player), the present invention may be utilized in a wide variety of personal and vehicular related uses.

For example, a tour route (either a walking tour or a riding tour) for a historic city (for example, London), may be provided on a compact disc. As the program is presented, signals are embedded in the program which upon arrival of the tour bus at specific stopping points trigger an indicator signal and enable a user to make on the spot reservations, for example, for that evening's presentation of Shakespeare's MacBeth at the Globe Theater in London, England. In order to accommodate a tourist's busy schedule, the present invention may also be conFIG.d to arrange bookings of performances such that they are compatible with a user's schedule maintained, for example, on a PDA. The present embodiment enables a user to book reservations for the play, save the location of the theater, obtain directions from their hotel to the theater, and complete all transactional details such that the user merely needs to arrive and proceed to their seats prior to show time.

Similarly, the present invention may be utilized in museums to provide directions to various areas of a museum and to allow a user to purchase items (for example, books and posters) related to an exhibit by merely responding to an indicator signal and designating a good/service desired to be obtained. For example, a user taking an audio tour of the Louvre museum in Paris, France, while viewing the Mona Lisa, is preferably provided with an indicator signal designating that additional works of art are on display and a more detailed book on Leonardo Da Vinci's life and works is immediately available for sale. Upon the user providing a command to the system to purchase such book, the system preferably automatically notifies a library attendant to provide the user with the book and automatically charges, for example, the user's credit card which is being suitably held as a deposit on the CD guide system. In order to facilitate such transactions, the system is preferably equipped with a location determination, which information is then provided to the library attendant in order to ensure delivery of the book to the correct patron. Further, the user could also input location information, such as where in the gallery they are located, and other information. Other identifiers, for example, a digital photo identification taken at the time of check out, could also be used to identify the user in a crowded gallery - the digital photo being provided via a programming signal to the attendant to identify the user. Other user identification devices, such as electronic tracking signals may be used by the present invention as desired.

As such, the present invention may be utilized in practically any environment wherein a user is receiving a programming signal and the user desires additional information or to make a purchase relating to the content of the programming signal. The present invention may be accomplished using any desired combination of hardware, software, location determination devices or techniques (or their absence thereof), and communications links, however, in the preferred embodiment an access system capable of receiving a programming signal containing an embedded address, a wireless communications links, a GPS navigation unit, and a MOTES payment and identification system are combined into a single system which provides the before mentioned features and functions.

While the invention has been particularly described and illustrated with reference to preferred embodiments thereof, it will be understood by those skilled in the art that changes in the above description or illustration may be made with respect to form or detail without departing from the spirit and scope of the invention.

1. A system for expediting transactions necessary to acquire goods/services from a provider, wherein additional information, including directions from a current location to a provider location, related to the goods/services is available from an information source related to a program provided in a programming signal, comprising:
a receiver for receiving a programming signal and an address associated with a provider of additional information related to a program provided in the programming signal;
an access controller, operable connected to the receiver, for decoding the address;
a user interface for entering user commands to access the additional information;
a communications unit for establishing a link, upon the user command, with the provider; and
a MOTES interface device which expedites the acquiring of goods/services by the user from the provider.

2. The system of claim 1, wherein the system further comprises a location determination unit for determining a current location of the receiver, and wherein a direction determination device uses the current location to determine directions to a destination location.

3. The system of claim 1, wherein the programming signal is at least one selected from the group consisting of: a radio broadcast signal and a television broadcast signal.

4. The system of claim 1, wherein the programming signal comprises at least one selected from the group consisting of: an audio signal, a video signal, and a combined audio and video signal.

5. The system of claim 1, wherein the system further comprises a storage device selected from the group consisting of: a digital versatile disc, a compact disc, a video tape, a magnetic tape, a hard disc drive, an optical storage device, a magnetic storage device, a portable nonvolatile memory device, a continuously powered volatile memory device, a memory card, a remote database, and a local database.

6. The system of claim 5, wherein the storage device stores the programming signal.

7. The system of claim 5, wherein the storage devices stores user information utilized to expedite the acquiring of goods/services by the user from the provider.

8. The system of claim 7, wherein the user information further comprises at least one incidence of information selected from the group consisting of: user identification information, payment information, location information, preferences, and delivery information.

9. The system of claim 7, wherein the user information is communicated to the provider prior to arrival of the user at a destination location.

10. The system of claim 7, wherein the user information is communicated to the provider at the time of arrival of the user at a destination location.

11. The system of claim 7, wherein the user information is communicated to the provider electronically.

12. The system of claim 7, wherein the user information is communicated to the provider verbally.

13. The system of claim 8, whereupon arrival of the user at a destination location, the user has completed any transactional requirements and is ready to receive the goods/services.

14. The system of claim 8, where upon arrival of the user at a destination location, the user information is communicated to the provider via a wireless signal.

15. The system of claim 14, wherein the wireless signal further comprises a MOTES signal.

16. The system of claim 1, wherein the programming signal is received via at least one transmission medium selected from the group consisting of: satellite broadcast, television broadcast, cable, the Internet, public network, private network, wireless telecommunications link, wireless network, and a radio frequency broadcast.

17. The system of claim 16, wherein the programming signal is encrypted.

18. The system of claim 1, wherein the programming signal contains an audio program and the system further comprises at least one speaker for presenting the audio program.

19. The system of claim 1, wherein the programming signal contains a video program and the system further comprises a video monitor for presenting the video program.

20. The system of claim 1, wherein the address is embedded in the programming signal.

21. The system of claim 1, wherein the address is transmitted separately from the programming signal.

22. The system of claim 1, wherein the address is associated with an online information provider.

23. The system of claim 1, wherein the address is associated with an information source accessible by a network selected from the group consisting of: Internet, Intranet, private network, and a point-to-point network.

24. The system of claim 1, wherein the system further comprises:
an address extractor, in communications with the receiver, which extracts the address from the programming signal; and
an indicator signal generator, which upon receipt of the address generates an indicator signal.

25. The system of claim 1, wherein the address is a database file designator.

26. The system of claim 2, wherein the location determination unit further comprises a GPS receiver which receives GPS satellite signals and determines the current location of the user.

27. The system of claim 2, wherein the location determination unit utilizes measurements accomplished via at least one methodology selected from the group consisting of: differential GPS, a street address, an intersection, a latitude and longitude, and a measurement of time, distance and direction from a known location.

28. The system of claim 1, wherein the user interface further comprises at least one device selected from the group consisting of: a HUD unit, voice command recognition device, a keypad, a video monitor, a speaker, a computing device, a voice activated trigger, and a printer

29. The system of claim 1, wherein the additional information includes a menu of options provided by the provider and available for selection by the user.

30. The system of claim 29, wherein the user selects an option via the user interface device.

31. The system of claim 29, wherein the user specifies a good/service not provided on the menu of options, via the user interface device, to the provider.

32. The system of claim 1, wherein the provider is co-located at a destination location.

33. The system of claim 1, wherein the provider is remote to a destination location and the provider receives an order from the user for at least one good/service and communicates the order to an affiliate at the destination location for fulfilling.

34. The system of claim 33, wherein the order is received from the customer by the provider over an Internet link.

35. A method of expediting a provisioning of goods/services to a user at a destination location related to an address provided in a programming signal, in response to a user request to receive the goods/services upon receiving an indication in the programming signal that the additional information pertaining to the goods/services are available, comprising:
receiving additional information in which a user has indicated an interest, wherein the additional information relates to an address related to a program provided in a programming signal;
presenting the additional information to the user;
receiving a selection by the user of at least one good/service provided by a provider related to the additional information;
accessing an identifier for the user;
determining a current location of a user receiving the additional information;
communicating the current location, the selection, and the identifier to the provider;
receiving an identification of a destination location associated with the address from the provider; and
providing an identification of the destination location to the user;
whereupon arriving at the destination location, the user identifier is verified and the user is provided with the good/service selected by the user on an expedited basis.

36. The method of claim 35, wherein the programming signal is at least one selected from the group consisting of: a radio broadcast signal and a television broadcast signal.

37. The method of claim 35, wherein the programming signal comprises at least one signal selected from the group consisting of: an audio signal, a video signal, and a combined audio and video signal.

38. The method of claim 35, wherein the additional information is received upon the user indicating an interest in an address related to the program and the method further comprises the steps of:
receiving the programming signal;
receiving an address related to a program provided in the programming signal;
generating an indication to the user that the additional information is available;
receiving a command from the user to obtain the additional information; and
establishing a communications link with the provider of the additional information.

39. The method of claim 38, wherein the address is embedded in the programming signal and the method further comprises extracting the address from the programming signal.

40. The method of claim 3 8, wherein the address is received independently of the programming signal.

41. The method of claim 35, wherein the programming signal is a satellite signal.

42. The method of claim 35, wherein the address further comprises an address associated with at least one network selected from the group consisting of: an Intranet, a private network, and a point-to-point connection.

43. The method of claim 35, wherein the programming signal is a previously recorded signal.

44. The method of claim 35, wherein the address further comprises an Internet address.

45. The method of claim 44, wherein the Internet address is accessed via at least one of a private network and a public network.

46. The method of claim 44, wherein the Internet address is accessed via an Internet portal and the additional information is a web page hosted by an Internet service provider at the Internet address.

47. The method of claim 35, wherein the additional information is presented to the user in at least one format selected from the group consisting of: an audio format, a video format, a graphical format, and a multimedia format.

48. The method of claim 35, wherein the selection by the user of at least one good/service provided by a provider related to the additional information is received via a user interface device.

49. The method of claim 35, wherein the identifier of the user is accessed from a data storage device selected from the group consisting of: a digital versatile disc, a compact disc, a video tape, a magnetic tape, a hard disc drive, an optical storage device, a magnetic storage device, a portable non-volatile memory device, a continuously powered volatile memory device, a memory card, a remote database, and a local database.

50. The method of claim 35, wherein the identifier of the user further comprises at least one incidence of information selected from the group consisting of:- user identification information, payment information, location information, user preferences, and delivery information.

51. The method of claim 35, wherein the programming signal is stored in a data storage device and the method further comprises retrieving the programming signal from the data storage device and presenting the programming signal to the user.

52. The method of claim 35, wherein the additional information is stored in and received from a data storage device.

53. The method of claim 35, wherein the additional information is received via at least one device selected from the group consisting of: a personal data assistant, a cellular telephone, a wireless telecommunications device, a Palm device, a wired telecommunications device, a radio, a computer workstation, a set top box, a television, and a receiver of a broadcast signal.

54. The method of claim 53, wherein the device further comprises at least one of a display screen, a speaker, and a headset on which the additional information is presented to the user.

55. The method of claim 53, wherein the device is located in an automobile.

56. The method of claim 53, wherein the device is a hand held device.

57. The method of claim 35, wherein the step of determining the current location of the user is accomplished using at least one location determination methodology selected from the group consisting of: Global Positioning System, distance measuring equipment, time and frequency based changes in signals, Loran, radio frequency triangulation, intersection of radio signals with radials, and 911 based location identifications.

58. The method of claim 35, wherein the step of determining the current location of the user further comprises:
receiving Global Positioning Satellite (GPS) signals; and
determining the current location of the user based upon the GPS signals.

59. The method of claim 58, wherein the step of determining a current location of the user based upon the GPS signals further comprises the steps of:
receiving a differential GPS signal; and
utilizing the differential GPS signal in conjunction with the GPS signal to determine the current location of the user.

60. The method of claim 35, wherein the step of communicating the current location, the selection, and the identifier to the provider is accomplished via a communications medium selected from the group consisting of: a wireless telecommunications system, a cellular telephone network, the Internet, a private network, a public network, a point-to-point network, and a wired telecommunications system.

61. The method of claim 35, wherein the step of receiving an identification of a destination location associated with the address further comprises:
obtaining a listing of at least one destination location;
comparing the listing of the at least one destination location against the current location of the user; and
identifying from the listing a destination location closest to the current location of the user.

62. The method of claim 61, wherein the step of identifying a destination location closest to the current location of the user is based upon at least one determination selected from the group consisting of: a determination based upon distance, a determination based upon commute time, a determination based upon route, and a determination based upon a time of day.

63. The method of claim 62, wherein the determination based upon a time of day further comprises a consideration of at least one time variable selected from a group consisting of: a departure time, an arrival time, and a return time for the user.

64. The method of claim 61, wherein the method further comprises the step of:
pre-identifying areas within which locations are to be excluded from consideration;
eliminating from the listing of destinations those locations within areas pre-identified;
comparing those locations remaining in the listing after the step of eliminating has been accomplished against the current location; and
identifying from the locations remaining a destination closest to the current location.

65. The method of claim 35, wherein the identifier is compatible with a MOTES system which enables the user's identity and payment information to be automatically determined upon arrival of the user at the destination location.

66. The method of claim 35, wherein the method further comprises completing at least one transactional requirement necessary for the user to expeditiously acquire the at least one good/service.

67. The method of claim 66, wherein all the transactional requirements are accomplished prior to the arrival of the user at the destination location.

68. The method of claim 66, wherein at least one transactional requirement is accomplished upon arrival of the user at the destination location.

69. The method of claim 66, wherein at least one transaction requirement is accomplished, at least in part, by providing user information electronically to the provider.

70. The method of claim 66, wherein at least one transaction requirement is accomplished, at least in part, by providing user information verbally to the provider.

71. The method of claim 35, wherein the step of providing an identification of the destination location to the user further comprises providing directions from the current location to the destination location.

72. The method of claim 71, wherein the step of providing directions further comprises the steps of generating a map showing a recommended route from the current location to the destination location.

73. The method of claim 71 , wherein the step of providing directions to the user further comprises:
transmitting the address and the current location to a data processing center;
accessing via a communications link between the data processing center and an online information provider a data file containing a listing of at least one destination location, the data file being identified by the address;
comparing the listing of at least one destination location with the current location to determine a destination location closest to the current location;
providing the destination location identified as closest and the current location to a mapping program, the mapping program determining directions from the destination location to the current location; and
providing the directions determined by the mapping program to the user.

74. The method of claim 73, wherein the directions determined by the mapping program are presented as a map and the method further comprises the step of displaying the directions overlaid on the map on a video display device.

75. The method of claim 35, wherein the method after the steps of providing an identification of the destination location to the user further comprises:
monitoring a location of the user as the user travels from the current location to the destination location;
generating an indicator signal when the user deviates from a direction provided to user, the direction indicating a preferred route from the current location to the destination location;
generating a second set of directions from a new current location to the destination location; and
providing the second set of directions to the user.

76. The method of claim 75, wherein the method further comprises the steps of providing updates to the provider, wherein the updates provide a more accurate estimation of the current location of the user and an estimated time of arrival of the user at the destination location.

77. The method of claim 35, wherein the method further comprises:
accessing a database of locations frequently visited by the user;
selecting a frequently visited location from the database;
determining directions from the destination location to a selected frequently visited location; and
providing the directions to the user

78. A computer readable medium containing instructions for expediting the provisioning of goods/services to a user by a location related to an address provided in a programming signal, in response to a user request to receive such goods/services upon receiving an indication in the programming signal that the additional information pertaining to such goods/services are available, by:
receiving additional information in which a user has indicated an interest, wherein the additional information relates to an address related to a program provided in a programming signal;
presenting the additional information to the user;
receiving a selection by the user of at least one good/service provided by a provider related to the additional information;
accessing an identifier for the user;
determining a current location of a user receiving the additional information;
communicating the current location, the selection, and the identifier to the provider;
receiving an identification of a destination location associated with the address from the provider; and
providing an identification of the destination location to the user;
whereupon arriving at the destination location, the user identifier is verified and the user is provided with the good/service selected by the user on an expedited basis via a MOTES system.

79. A system for providing goods/services to a user on an expedited basis upon reception of a programming signal and an address identifying additional information related to a program in the programming signal, and determining directions from a current location of the user to a destination location, wherein the destination location is affiliated with a provider of the additional information, comprising:
a user system;
a provider system;
a programming transmission system;
a position determination system;
a communications system connecting the user system with the provider system; and
a transaction processing system;
whereupon receipt of a programming signal containing a program, an address identifying a provider of additional information related to the program, and a command to retrieve the additional information by a user, the user system establishes a communications link with the provider, obtains the additional information, presents the additional information to the user and upon a further request by the user to acquire goods/services provided by the provider accesses the transaction processing system and expedites a transaction between the user and the provider for the requested goods/services, while also providing directions to the user from a current location of the user to a destination location affiliated with the provider and capable of fulfilling the request.

80. The system of claim 79, wherein the user system further comprises:
a programming signal receiving unit which receives a programming signal transmitted by the programming transmission system, the programming signal containing an address identifying a provider of additional information related to a program in the programming signal;
a communications unit for establishing a communication link between the provider and the user;
a user interface device;
a Global Positioning System receiving unit for determining a current location of a user;
a MOTES interface device, which designates a user to a provider upon arrival of the user at a destination location affiliated with the provider; and
a processor for controlling the user system;
whereupon receipt of a user command selecting an indicator signal which identifies an address extracted from the programming signal, the processor establishes a communications link with the provider of additional information identified by the extracted address, obtains the additional information from the provider, and presents the additional information to the user, and upon a user indication of desire to procure a good/service related to the additional information and affiliated with the provider, the processor obtains a current location of the user via the GPS receiving unit and communicates such current location information and request to procure the good/service to the provider; whereupon receipt of a return communications from the provider of a designation of a destination providing the requested good/service or alternatives thereof, the processor communicates the direction information to the user and, upon receipt of an acceptance by the user of the designation of a destination, communicate at least one user identifier to the provider; whereupon arrival of the user at the designated location the user is automatically identified to the provider via the MOTES interface device.

81. The system of claim 80, wherein the user identifier further comprises at least one identifier selected from the group consisting of: user identification information, payment information, location information, preferences, and delivery information.

82. The system of claim 80, wherein the MOTES interface device communicates user information automatically via a programming signal.

83. The system of claim 79, wherein the provider system further comprises:
a data processing center;
a location order processor;
a MOTES reader; and
a communications link between the data processing center and the location order processor.

84. The system of claim 83, wherein the data processing center, upon receiving a request for additional information from a user, accesses at least one database accessible via a network connection, retrieves the additional information from the database, and communicates the additional information to the user system.

85. The system of claim 84, wherein the network is at least one selected from the group consisting of: the Internet, intranet, private network, public network, and a point-to-point network.

86. The system of claim 83, wherein the data processing center accesses information from an advertiser's server in determining which goods/services are available by a provider for providing to a user in an expedited manner.

87. The system of claim 83, wherein the location order processor and the data processing center are co-located.

88. The system of claim 83, wherein the MOTES reader further comprises a sensor which automatically detects a signal generated by a vehicle associated with the user, upon arrival of the vehicle at the destination.

89. The system of claim 83, wherein the communications link between the data processing center and the location order processor further comprises a network connection established via at least one selected from the group consisting of: Internet, intranet, private network, public network, and a point-to-point network.

90. The system of claim 79, wherein the programming transmission system further comprises at least one system selected from the group consisting of: broadcast television, broadcast radio, cable, satellite, wireless telecommunication link, Internet, private network, public network, and a wireless network.

91. The system of claim 79, wherein the programming signal further comprises at least one selected from the group consisting of: a radio program, a television program, an advertisement, a game show program, a sports program, a music program, a music video program, a news program, and a motion picture program.

92. The system of claim 79, wherein the position determination system utilizes position determinations determined via a system selected from the group consisting of: a GPS receiver, a differential GPS receiver, a street address, an intersection, a latitude and longitude, and a measurement of time, distance and direction from a known location.

93. The system of claim 79, wherein the communications system connecting the user system and the provider system further comprises a wireless communications link.

94. The system of claim 79, wherein the transaction processing system further comprises a MOTES processing system.

95. A method of expediting the provisioning of at least one good/service by a provider to a user in response to the reception of a programming signal containing an indication that additional information related to the programming signal is available, and upon an indication by the user of a desire to purchase at least one good/service provided by the provider upon receiving directions from a current location of the user to a destination location associated with the provider, comprising:
receiving a programming signal;
receiving an indicator that additional information related to the programming signal is available;
communicating a request from a user for information to a provider, wherein the request contains an identification of a first location and an address received by the user in conjunction with a programming signal;
accessing the additional information upon user command, wherein the additional information includes an indication of at least one good/service available for procuring from the provider;
selecting at least one good/service provided by the provider;
identifying a destination associated with the address based upon the first location;
providing directions from the first location to the destination; and
communicating user identifiers to the destination, wherein the user identifiers are utilized to expedite the providing of the identified goods/services to the user upon arrival of the user at the destination.

96. The method of claim 95, wherein the programming signal is received via at least one communications medium selected from the group consisting of: cable, satellite, broadcast radio, broadcast television, Internet, intranet, private network, telecommunications system, wireless telecommunications network, public network, and a point-to-point network.

97. The method of claim 95, wherein the indicator is received as at least one of an audible, visual, and tactile signal.

98. The method of claim 95, wherein the method further comprises determining the first location of the user using at least one determination method selected from the group consisting of: GPS, differential GPS, an address, an intersection, latitude and longitude, and a measurement of time, distance and direction from a known location.

99. The method of claim 95, wherein the request for additional information is communicated via a wireless network.

100. The method of claim 95, wherein the request for additional information is communicated via an Internet connection.

101. The method of claim 95, wherein the step of selecting at least one good/service provided by the provider further comprises:
receiving an indication of a promoted good/service currently provided by the provider;
receiving a menu listing of at least one good/service provided by the provider;
selecting at least one of the promoted good/service and a good/service listed on the menu;
communicating the selection of the good/service to the provider; and
determining at least one location which provides the good/service and from which it is most convenient for the user to receive the good/service.

102. The method of claim 95, wherein the directions are provided in at least one form selected from the group consisting of: a map, indicator signals, audible, visual, and written.

103. The method of claim 95, wherein the user identifiers are communicated at the time of selection of a good/service by the user.

104. The method of claim 95, wherein the user identifiers are communicated upon arrival of the user at the destination.

105. The method of claim 95, wherein the user identifiers are communicated automatically.

106. The method of claim 95, wherein the user identifiers are communicated upon command from the user.

107. The method of claim 95, wherein the user identifiers are communicated via a MOTES system.

108. The method of claim 95, wherein the user identifiers are communicated via at least one selected from the group consisting of: the Internet, intranet, private network, public network, point-to-point network, wireless telecommunications link, and a wireless network.

109. The method of claim 95, wherein user identifier further comprises user payment information such that upon arrival of the user at the destination, payment for the goods/services is automatically accomplished.

110. The method of claim 95, wherein the step of identifying a destination associated with the address based upon the first location further comprises the steps of:
accessing a data file designated by the address;
determining the availability of the goods/services selected by the user;
determining an estimated waiting time for delivery of the goods/services; and
selecting from the data file a destination based upon the first location, the availability and the estimate waiting time;
whereupon arrival of the user at the destination, the goods/services are available for an expedited provisioning to the user.

111. The method of claim 110, wherein the data file further comprises an Internet site hosted by an Internet Service Provider.

112. A provider system for providing at least one good/service to a user, whereupon the goods/services selected by the user is related to a program associated with additional information, the program being received by a user system, such that directions to a destination location affiliated with the provider and the expedited delivery of the goods/services to the user upon arrival at the destination location is provided to the user upon receiving a command from the user to receive the additional information and acquire the related goods/services, comprising:
a location order processor, which receives a request from a user for a good/service related to a program received in a programming signal; and
a MOTES reader;
whereupon receiving a request from a user for the good/service, the location order processor instructs the destination location to prepare the order based upon an estimated time of arrival of the user at the destination and expedites at least one transactional requirements such that upon arrival of the user at the destination and detection of the user by the MOTES reader the goods/services are ready for expedited provisioning to the user.

113. The provider system of claim 112, wherein the request is received from a data processing center which receives the request from the user for the goods/services and the user's current location and determines which provider location is best capable of fulfilling the user's request.

114. The provider system of claim 112, wherein the MOTES reader detects the arrival of the user via an electromagnetic signal received from a vehicle utilized by the user.

115. The provider system of claim 112, wherein the MOTES reader detects the arrival of the user via a code received from the user upon arrival at the destination.

116. The provider system of claim 112, wherein the MOTES reader processes at least one transactional requirement automatically upon arrival of the user at the destination.

117. The provider system of claim 116, wherein the transactional requirement includes billing and payment information.

118. A data processing center comprising:
a communications device;
a data file access device; and
a data processor;
whereupon receiving from a user a designation of a first location, a designation of at least one good/service desired to be procured by the user, and an address via the communications device, the data processor directs the data file access device to retrieve a data file identified by the address which provides an identification of at least one destination capable of expeditiously providing the designated goods/services, determines at least one destination based upon the contents of the data file and the first location, returns a result of the determination via the communications device to the user, and upon acceptance of the result of the determination by the user automatically completes those transactional requirements necessary to expedite the delivery of goods/services to the user upon arrival at the destination.

119. The data processing center of claim 118, wherein the communications device facilitates the establishment of wireless communications links between the user and the data processor.

120. The data processing center of claim 118, wherein the data file access device establishes a communications link with an online information provider identified by the address and retrieves the data file from the online information provider.

121. The data processing center of claim 120, wherein the communications link further comprises a connection established utilizing at least one selected from the group consisting of: the Internet, a private network, a public network, and a dial-up connection.

122. The data processing center of claim 120, wherein the data processor further comprises a customer service representative and the data file access device further comprises a computer workstation, wherein the customer service representative, upon receiving from the user a designation of a first location, a desired good/service and an address, utilizes the computer workstation to retrieve an identification of at least one destination identified by the address in a data file as capable of expeditiously providing the requested good/service, and communicates the location of the destination to the user.

123. The data processing center of claim 122, wherein the customer service representative provides to the user directions from the first location to a destination.

124. The data processing center of claim 118, wherein the directions are communicated electronically to the user.

125. The data processing center of claim 118, wherein the data processor further comprises an automated data processing center which automatically receives requests and processes at least one transactional requirement necessary to expeditiously provide the goods/services to the user.

126. The data processing center of claim 125, wherein the automated data processing center further comprises a MOTES processing system.

127. A computer system for expediting the provisioning of at least one good/service to a user based upon a determination of a destination based upon a current location of the user and an address related to the good/service, the address being provided in conjunction with a programming signal, comprising:
a communications component that establishes communications connectivity between a user and the computer system, and the computer system and at least one online information provider;
an address processing component that determines which online information provider to contact based upon an address received from the user, establishes a connection with the online information provider via the communications component, and retrieves a listing of at least one destination associated with the online information provider;
a destination selection component that receives the listing of at least one destination from the address processing component and identifies at least one destination as a final destination;
a mapping component that receives the final destination and the current location, generates directions from the current location to the final destination, and provides a result of the direction generation to the communications component for communication to the user; and
a transaction expediting component that expedites the processing of at least one transactional component necessary to expeditiously provide at least one good/service to the user at the destination in response to a request by the user for the good/service.

128. The computer system of claim 127, wherein the communications component controls the operation of a modem provided in the computer system.

129. The computer system of claim 127, wherein the address processing component further comprises a Web browser which establishes, via the communications component, connectivity between the computer system and at least one online information provider via a connection selected from the group consisting of: an Internet connection, a private network connection, a public network connection, and a dial-up connection.

130. The computer system of claim 127, wherein the destination selection component identifies a destination as the final destination based upon at least one parameter selected from the group consisting of: a commute time, a commute distance, and a recommended route between each of the destination and the current location.

131. The computer system of claim 127, wherein the transaction expediting component further comprises a MOTES system.

132. The computer system of claim 131, wherein the MOTES system processes information pertaining to the user selected from the group consisting of: payment information, user identification, user preferences, and delivery information.

133. A computer-readable medium including a program code, the program code including instructions for use in expediting the provisioning of at least one good/service based upon a determination of directions from a first location to a destination identified by an address received by a user in a programming signal, the address identifying a provider of additional information associated with the at least one good/service, wherein the program code comprises:
a data file of addresses;
a data file of destinations corresponding to the addresses;
a data file of at least one good/service associated with at least one of the destinations; and
a data file of at least one user identifier;
whereupon receiving the address and a user identifier, the provisioning of the at least one good/service can be expedited at the destinations retrieved from the data file.

134. The computer-readable medium of claim 133, wherein the medium is one selected from the group consisting of: a compact disc, a digital versatile disc, a hard disc drive, random access memory, read only memory, a portable non-volatile memory device, a continuously powered volatile memory device, an optical memory device, and a magnetic memory device.

135. A signal for transmitting information used to expedite the provisioning of at least one good/service associated with an address related to a programming signal, comprising:
a first portion identifying an address that a user received in conjunction with a programming signal;
a second portion identifying a first location;
a third portion identifying a destination; and
a fourth portion identifying at least one user identifier;
wherein the at least one user identifier is utilized to expedite the provisioning of at least one good/service related to the address and the destination.

136. The signal of claim 135, wherein the information is transmitted via a wireless telecommunications link.

137. The signal of claim 135, wherein the information is transmitted via a hard-wired connection.

138. The signal of claim 135, wherein the second portion further comprises a GPS based identification of a current location of the user.

139. The signal of claim 135, wherein the second portion further comprises an identification of a current location of the user based upon a location determined using one selected from the group consisting of. DME determinations, Loran measurements, 91 1 based measurements, intersection identification, landmark designations, street address designations, latitude and longitude measurements, and time, distance and direction calculations from a known location.

140. The signal of claim 135, wherein the first portion identifies an address associated with an online information provider accessible via a connection selected from the group consisting of: an Internet connection, a private network connection, a public network connection, a direct hard-wired connection, and a dial-up connection.

141. A computer-readable data transmission medium utilized by a data processing center containing a data structure comprising:
a first portion identifying an address that a user received in conjunction with a programming signal;
a second portion identifying a first location;
a third portion identifying a destination; and
a fourth portion identifying at least one user identifier;
wherein the at least one user identifier is utilized to expedite the provisioning of at least one good/service related to the address and the destination.

142. The computer-readable data transmission medium of claim 141, wherein the second portion further comprises directions provided on a map.

143. The computer-readable data transmission medium of claim 141, wherein the second portion further comprises directions provided verbally.

144. The computer-readable data transmission medium of claim 141, wherein the second portion further comprises directions provided in a textual format.

145. The computer-readable data transmission medium of claim 141, wherein the data transmission medium is communicated from the data processing center to a user over a wireless communications link.

146. The computer-readable data transmission medium of claim 141, wherein the data transmission medium is generated by a local storage device located at the data processing center and is transmitted from the local storage device to a user.

147. A method in a computer system for communicating at least one user identifier for expediting the provisioning of at least one good/service to the user by a provider at a destination related to additional information identified to a user's system in an address transmitted in conjunction with a programming signal and received by the user's system, the method comprising:
receiving the address and a first location from the user's system;
identifying at least one good/service provided by the provider related to the address;
in response to receiving the address and a request from the user for at least one good/service:
establishing a communications connection with an online information provider associated with the address;
determining at least provider providing the at least one good/service requested by the user;
retrieving at least one destination provided by the online information provider;
in response to receiving the first location and the request for the at least one good/service;
determining which of the retrieved destination providing the requested good/service is closest to the first location; and
transmitting a result of the determination to the user's system; wherein the result identifies a destination providing the requested at least one good/service to the user on an expedited basis.

148. The method of claim 147, wherein the method further comprises the steps of transmitting each destination provided by the online information provider to the user's system.

149. The method of claim 147, wherein the step of determining which of the retrieved destination is closest to the first location is determined based upon at least one variable selected from the group consisting of: commute time, commute distance, and preferred route.

150. The method of claim 147, wherein the first location is based upon a location measurement accomplished using at least one selected from the group consisting of: GPS measurements, DME determinations, Loran measurements, 911 based measurements, an intersection identification, landmark designations, street address designations, latitude and longitude measurements, and time, distance and direction calculations from a known location.

151. A user interface providing an interface between a user and an access system, wherein the access system receives an address transmitted in conjunction with a programming signal and a first location, provides to the user an indication of a destination associated with the address based upon the first location the user interface, and expedites at least one transactional element needed to acquire at least one good/service by the user at the destination; comprising:
a user input device; and
a user output device;
whereuin the user input device enables a user to request additional information related to an address extracted by the access system from a programming signal and the user output device enables the user to receive the additional information.

152. The user interface of claim 151, wherein the user input device is selected from the group consisting of: a keyboard, a pushbutton, a computing device, microphone, voice recognition system, and a mouse.

153. The user interface of claim 151, wherein the user output device is selected from the group consisting of: a flat screen display, LED display, printer, map generating device, television monitor, audio presentation and reception device, heads-up display, and a visual indicator.

154. A method expediting a provisioning of goods/services to a user in response to a user request to receive the goods/services associated with a provider of such goods/services, wherein an indication of that additional information relating to the provider is provided in a programming signal received by the user, comprising:
receiving additional information in which a user has indicated an interest, wherein the additional information relates to an address related to a program provided in a programming signal;
presenting the additional information to the user;
receiving a selection by the user of at least one good/service provided by a provider related to the additional information;
accessing an identifier for the user;
communicating the selection and the indentifier to the provider;
receiving an identification of a destination location associated with the provider;
providing an identification of the destination location to the user; and
expediting the procuring of the goods/services by the user at the destination location via a MOTES system.

155. The method of claim 154, wherein the additional information is received upon the user indicating an interest in an address related to the program and the method further comprises the steps of:
receiving the programming signal;
receiving an address related to a program provided in the programming signal;
generating an indication to the user that the additional information is available;
receiving a command from the user to obtain the additional information; and
establishing a communications link with the provider of the additional information.

156. The method of claim 155, wherein the address is embedded in the programming signal and the method further comprises extracting the address from the programming signal.

157. The method of claim 154, wherein the method further comprises the step of determining a current location of the user.

158. The method of claim 157, wherein the step of determining a current location of the user is based upon GPS signals.

159. The method of claim 154, wherein the MOTES system enables the user's identity and payment information to be automatically determined upon arrival of the user at the destination location.

160. The method of claim 154, wherein the MOTES system enables the user's identity and payment information to be automatically determined prior to arrival of the user at the destination location.

161. The method of claim 154, wherein the MOTES system enables the user's identity and payment information to be automatically determined after arrival of the user at the destination location.

162. A computer readable medium containing instructions for expediting the provisioning of goods/services to a user by a location related to an address provided in a programming signal, in response to a user request to receive such goods/services upon receiving an indication in the programming signal that the additional information pertaining to such goods/services are available, by:
receiving additional information in which a user has indicated an interest, wherein the additional information relates to an address related to a program provided in a programming signal;
presenting the additional information to the user;
receiving a selection by the user of at least one good/service provided by a provider related to the additional information;
accessing an identifier for the user;
communicating the selection and the identifier to the provider;
receiving an identification of a destination location associated with the address from the provider;
providing an identification of the destination location to the user; and
expediting the procuring of the goods/services by the user at the destination location via a MOTES system.

163. The method of claim 162, wherein the additional information is received upon the user indicating an interest in an address related to the program and the method further comprises the steps of:
receiving the programming signal;
receiving an address related to a program provided in the programming signal;
generating an indication to the user that the additional information is available;
receiving a command from the user to obtain the additional information; and
establishing a communications link with the provider of the additional information.

164. The method of claim 163, wherein the address is embedded in the programming signal and the method further comprises extracting the address from the programming signal.

165. The method of claim 162, wherein the method further comprises the step of determining a current location of the user.

166. The method of claim 165, wherein the step of determining a current location of the user is based upon GPS signals.

167. The method of claim 162, wherein the MOTES system enables the user's identity and payment information to be automatically determined upon arrival of the user at the destination location.

168. The method of claim 162, wherein the MOTES system enables the user's identity and payment information to be automatically determined prior to arrival of the user at the destination location.

169. The method of claim 162, wherein the MOTES system enables the user's identity and payment information to be automatically determined after arrival of the user at the destination location.

170. A system for providing goods/services at a destination location to a user on an expedited basis upon reception of a programming signal and an address identifying additional information related to a program in the programming signal, comprising:
a user system;
a provider system;
a programming transmission system;
a communications system connecting the user system with the provider system; and
a transaction processing system;
whereupon receipt of a programming signal containing a program, an address identifying a provider of additional information related to the program, and a command to retrieve the additional information by a user, the user system establishes a communications link with the provider system, obtains the additional information, presents the additional information to the user and upon a further request by the user to acquire goods/services provided by a provider affiliated with the provider system accesses the transaction processing system and expedites a transaction between the user and the provider for the requested goods/services.

171. A method for expediting the provisioning of at least one good/service by a provider to a user in response to the reception of a programming signal containing an indication that additional information related to the programming signal is available, and upon an indication by the user of a desire to purchase at least one good/service provided by the provider upon receiving an indication of a destination location associated with the provider, comprising:
receiving a programming signal;
receiving an indicator that additional information related to the programming signal is available;
communicating a request from a user for information to a provider, wherein the request contains an address received by the user in conjunction with the programming signal;
accessing the additional information, wherein the additional information includes an indication of at least one good/service available for procuring from the provider;
selecting at least one good/service provided by the provider;
identifying a destination at which at least one selected good/service may be obtained; and
communicating user identifiers to the destination, wherein the user identifiers are utilized to expedite the providing of the identified good/service to the user.

172. The method of claim 171, wherein the user identifiers are communicated via a MOTES system.

173. The method of claim 171, wherein the step of selecting at least one good/service provided by the provider further comprises:
receiving an indication of a promoted good/service provided by the provider;
receiving a menu listing of at least one good/service provided by the provider;
selecting at least one of the promoted good/service and a good/service listed on the menu; and
communicating the selection of the good/service to the provider.

174. A computer system for expediting the provisioning of at least one good/service to a user based upon an address related to the good/service, the address being provided in conjunction with a programming signal, comprising:
a communications component that establishes communications connectivity between a user and a computer system, and the computer system and at least one online information provider;
an address processing component that determines which online information provider to contact based upon an address received from the user, establishes a connection with the online information provider via the communications component, and retrieves a listing of at least good/service associated with the online information provider;
a transaction expediting component that expedites the processing of at least one transactional component necessary to expeditiously provide at least one good/service to the user upon user request.

175. The computer system of claim 174, wherein the transaction expediting component further comprises a MOTES system.

176. The computer system of claim 175, wherein the MOTES system processes information pertaining to the user selected from the group consisting of: payment information, user identification, user preferences, and delivery information.

177. A system utilized to provide a good/service to a user based upon the reception of an address in a programming signal, wherein the address identifies the good/service and a destination at which the good/service may be obtained, comprising:
an access system which receives and processes a user request to receive a good/service related to an address extracted from a programming signal presented to the user; and
a user identifier communicating system, in communication with the access system, which communicates at least one user identifier to a receiving system located at a destination identified by the access system as providing the requested good/service;
whereupon arrival of the user at the destination the good/service is expeditiously provided to the user.

178. The system of claim 177 wherein the user identifier communicating system utilizes a MOTES system.

179. The system of claim 177, wherein the system further comprises a location determination system which determines a location of the access system and provides location information utilized to determine directions from the location of the access system to the destination.

180. The system of claim 177, wherein the location determination system utilizes GPS signals to determine the location of the access system on a real-time basis.
